(19) United States
(12) Patent Application Publication
(10) Pub. No.: US 2024/0119355 A1
(43) Pub. Date: Apr. 11, 2024

(54) HIERARCHICAL ONLINE CONVEX OPTIMIZATION

(71) Applicant: Telefonaktiebolaget LM Ericsson (publ), Stockholm (SE)

(72) Inventors: Gary Boudreau, Kanata, Ontario (CA); Hatem Abou-zeid, Calgary, Alberta (CA); Juncheng Wang, Toronto, Ontario (CA); Ben Liang, Whitby, Ontario (CA); Min Dong, Whitby, Ontario (CA)

(73) Assignee: Telefonaktiebolaget LM Ericsson (publ), Stockholm (SE)

(21) Appl. No.: 18/272,342

(22) PCT Filed: Jan. 12, 2022
(86) PCT No.: PCT/IB2022/050212

§ 371 Date: Jul. 13, 2023

Related U.S. Application Data
(60) Provisional application No. 63/144,257, filed on Feb. 1, 2021.

(51) Int. Cl. G06N 20/00; G06N 7/00

(52) U.S. Cl. CPC G06N 20/00; G06N 7/00

(57) ABSTRACT

A method for performing online convex optimization is provided. The method includes receiving, from two or more worker nodes, a local decision vector and local data corresponding to each of the two or more worker nodes. The method includes performing a multi-step gradient descent based on the local decision vector and the local data received from the two or more worker nodes. Performing the multi-step gradient descent includes determining a global decision vector and corresponding global information. The method includes sending, to each of the two or more worker nodes, the global decision vector and corresponding global information.

### TECHNICAL FIELD

Disclosed are embodiments related to online convex optimization.

### BACKGROUND

Many machine learning, signal processing, and resource allocation problems can be cast into a dynamic optimization problem with time-varying convex cost functions. Online convex optimization (OCO) provides the tools to handle dynamic problems in the presence of uncertainty, where an online decision strategy evolves based on the historical information [1], [2] (bracketed numbers refer to references at the end of this disclosure). OCO can be seen as a discrete-time sequential decision-making process by an agent in a system. At the beginning of each time slot, the agent makes a decision from a convex feasible set. The system reveals information about the current convex cost function to the agent only at the end of each time slot. The lack of in-time information prevents the agent from making an optimal decision at each time slot. Instead, the agent resorts to minimizing the regret, which is the performance gap between the online decision sequence and some benchmark solution. A desired online decision sequence should be asymptotically no worse than the performance benchmark, i.e., achieving regret that at most grows sublinearly over time.

Most of the early works on OCO studied the static regret, which compares the online decision sequence with a static offline benchmark [3], [4], [5], [6]. However, the optimum of dynamic problems is often time varying. As a rather coarse performance metric, achieving sublinear static regret may not be meaningful since the static offline benchmark itself may perform poorly. A more attractive dynamic regret was first proposed in [3], where the offline benchmark solution can be time varying. It is well known that in the worst-case, it is impossible to obtain sublinear dynamic regret, since drastic variations of the underlying systems can make the online problem intractable. Therefore, dynamic regret bounds are often expressed w.r.t. the accumulated system variations that reflect the hardness of the problem. Theoretical guarantees on the dynamic regrets for OCO with general cost functions were studied in [3], [7], and [8], while the case of strongly convex cost functions were studied in [9], [10], [11], and [12].

The above OCO frameworks do not consider the network heterogeneity on information timeliness and computation capacity in many practical applications. For example, consider the multiple transmission/reception point (TRP) cooperative network with non-ideal backhaul links for 5G New Radio (NR) [13], each TRP has a priori local channel state information (CSI) but less computation capacity compared with a central controller (CC). In mobile edge computing [14], the remote processors have timely information about the computing tasks but may offload some tasks to the edge server due to the limitation on local computation resources [15]. Another example is self-driving vehicular networks, where each vehicle moves based on its real-time sensing while reporting local observations to a control center for traffic routing or utility maximization. In these applications, data are distributed over the network edge and vary over time. Furthermore, the network edge needs to make real-time local decisions to minimize the global costs. However, due to the coupling of data and variables, the global cost function may be non-separable, i.e., it may not be expressed as a summation of local cost functions at the network edge.

Algorithms for non-separable global cost minimization problems, such as coordinated block descent [16] and alternating direction method of multipliers [17], [18] are centralized in nature, as they implicitly assume there is a central node that coordinates the iterative communication and computation processes. However, with distributed data at the network edge, centralized solutions suffer from high communication overhead and performance degradation due to communication delay. Furthermore, existing distributed online optimization frameworks such as parallel stochastic gradient descent [19], federated learning [20], and distributed OCO [21] are confined to separable global cost functions. Specifically, each local cost function depends only on the local data, which allows each node to locally compute the gradient without information about the data at all the other nodes. Therefore, these distributed online frameworks cannot be directly applied to non-separable global cost minimization problems, such as the multi-TRP cooperative precoding design problem considered in this invention, where downlink transmissions at the TRPs are coupled by broadcasting channels.

### SUMMARY

It is therefore challenging to develop an online learning framework that takes full advantage of the network heterogeneity on information timeliness and computation capacity, while allowing the global cost functions to be non-separable. In this work, we propose a new Hierarchical Online Convex Optimization (HiOCO) framework for dynamic problems over a heterogeneous master-worker network with communication delay. The local data may not be independent and identically distributed (i.i.d.) and the global cost function may not be separable. We consider network heterogeneity, such that the worker nodes have more timely information about the local data but possibly less computation resources compared with the master node. As disclosed here, HiOCO is a framework that takes full advantage of both the timely local and delayed global information, while allowing gradient descent at both the network edge and control center for improved system performance. Our incorporation of non-separable global cost functions over a master—worker network markedly broadens the scope of OCO.

According to a first aspect, a method for performing online convex optimization is provided. The method includes receiving, from two or more worker nodes, a local decision vector and local data corresponding to each of the two or more worker nodes. The method includes performing a multi-step gradient descent based on the local decision vector and the local data received from the two or more worker nodes, wherein performing the multi-step gradient descent comprises determining a global decision vector and corresponding global information. The method includes sending, to each of the two or more worker nodes, the global decision vector and corresponding global information.

According to a second aspect, a method for performing online convex optimization is provided. The method includes receiving, from a master node, a global decision vector and corresponding global information, wherein the global information has a time delay associated with it. The method includes performing a multi-step gradient descent based on the global decision vector and local data, wherein performing the multi-step gradient descent comprises determining a local decision vector. The method includes sending, to the master node, the local decision vector and local data.

According to a third aspect, a master node for performing online convex optimization is provided. The master node includes processing circuitry and a memory containing instructions executable by the processing circuitry. The processing circuitry is operable to receive, from two or more worker nodes, a local decision vector and local data corresponding to each of the two or more worker nodes. The processing circuitry is operable to perform a multi-step gradient descent based on the local decision vector and the local data received from the two or more worker nodes, wherein performing the multi-step gradient descent comprises determining a global decision vector and corresponding global information. The processing circuitry is operable to send, to each of the two or more worker nodes, the global decision vector and corresponding global information.

According to a fourth aspect, a worker node for performing online convex optimization, the worker node comprising processing circuitry and a memory containing instructions executable by the processing circuitry. The processing circuitry is operable to receive, from a master node, a global decision vector and corresponding global information, wherein the global information has a time delay associated with it. The processing circuitry is operable to perform a multi-step gradient descent based on the global decision vector and local data, wherein performing the multi-step gradient descent comprises determining a local decision vector. The processing circuitry is operable to send, to the master node, the local decision vector and local data.

According to a fifth aspect, a computer program is provided comprising instructions which when executed by processing circuitry of a node causes the node to perform the method of any embodiment of the first and second aspects.

According to a sixth aspect, a carrier containing the computer program of the fifth aspect is provided, wherein the carrier is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 illustrates an example network according to an embodiment.

FIG. 2 illustrates an example network according to an embodiment.

FIG. 3 illustrates a flow chart according to an embodiment.

FIG. 4 illustrates a flow chart according to an embodiment.

FIG. 5 illustrates an example network according to an embodiment.

FIG. 6 illustrates an example network according to an embodiment.

FIGS. 7-14 illustrate a graph according to an embodiment.

FIG. 15 illustrates a flow chart according to an embodiment.

FIG. 16 illustrates a flow chart according to an embodiment.

FIG. 17 is a block diagram of an apparatus according to an embodiment.

### DETAILED DESCRIPTION

In the seminal work of OCO [3], an online projected gradient descent algorithm achieved [symbol] (\sqrt{T}) static regret with bounded feasible set and gradient, where T is the total time horizon. The static regret was shown to be unavoidably Ω(\sqrt{T}) for general convex cost functions without additional assumptions and was further improved to [symbol] (log T) for strongly convex cost functions [4]. Moreover, [5] provided [symbol] (\sqrt{τT}) static regret in the presence of τ-slot delay and [6] studied OCO with adversarial delays. First introduced in [3], the dynamic regret of OCO has received a recent surge of interest [7], [8]. Strong convexity was shown to improve the dynamic regret bound in [9]. By increasing the number of gradient descent steps, the dynamic regret bound was further improved in [10]. The standard and proximal online gradient descent algorithms were respectively extended to accommodate inexact gradient in and [12]. Below, we compare the settings and dynamic regret bounds of these works in more details.

The above OCO algorithms are centralized. Distributed online optimization of a sum of local convex cost functions was studied in [21], [22], [23], [24], [25], [26], [27]. Early works on distributed OCO focused on static regret [21], [22], [23], [24] while more recent works studied dynamic regret [25], [26], [27]. However, existing distributed OCO works are over fully distributed networks with separable global cost functions.

Online frameworks such as Lyapunov optimization [28] and OCO have been applied to solve many dynamic problems in wireless systems. For example, online power control for wireless transmission with energy harvesting and storage was studied for single-hop transmission [29] and two-hop relaying [30]. Online wireless network virtualization with perfect and imperfect CSI were studied in [31] and [32]. Online projected gradient descent and matrix exponential learning were leveraged in [33] and [34] for uplink covariance matrix design. Dynamic transmit covariance design for wireless fading systems was studied in [35]. Online periodic precoding updates for wireless network virtualization was considered in [36]. The above works focused on centralized problems for single-cell wireless systems.

Multi-cell cooperative precoding via multiple base stations (BSs) at the signal level can effectively mitigate inter-cell interference, and this has been shown to significantly improve the system performance. However, traditional cooperative precoding schemes focused on centralized offline problems with instantaneous CSI available at the CC [37], [38], [39]. The TRPs defined in 5G NR are much smaller in size compared with the traditional BSs and therefore have limited computation power. Furthermore, non-ideal backhaul communication links in practice have received a surge of attention in the 5G NR standardization. In this work, we apply the proposed HiOCO framework to an online multi-TRP cooperative precoding design problem with non-ideal backhaul links, by taking full advantage of the CSI timeliness at the TRPs and computation resources at the CC.

We formulate a new OCO problem over a heterogenous master-worker network with communication delay, where the worker nodes have timely information about the local data but possibly less computation resources compared with the master node. At the beginning of each time slot, each worker node executes a local decision vector to minimize the accumulation of time-varying global costs. The local data at the worker nodes may be non-i.i.d. and the global cost functions may be non-separable.

We propose a new HiOCO framework that takes full advantage of the network heterogeneity in information timeliness and computation capacity. As disclosed here, HiOCO allows both central gradient descent at the master node and local gradient descent at the worker nodes for improved system performance. Furthermore, by communicating the aggregated global information and compressed local information, HiOCO can often reduce the communication overhead while preserving data privacy.

We analyze the special structure of HiOCO in terms of its hierarchical multi-step gradient descent with estimated gradients, in the presence of multi-slot delay. We prove that it can yield sublinear dynamic regret under mild conditions. Even with multi-slot delay, by increasing the estimated gradient descent steps at either the network edge or center, we can configure HiOCO to achieve a better dynamic regret bound compared with centralized inexact gradient descent algorithms.

We apply HiOCO to an online multi-TRP cooperative precoding design problem. Simulation under typical urban micro-cell Long-Term Evolution (LTE) settings demonstrates that both the central and local estimated gradient descent in HiOCO can improve system performance. In addition, HiOCO substantially outperforms both the centralized and distributed alternatives.

Embodiments disclosed here consider OCO over a heterogeneous network with communication delay, where the network edge executes a sequence of local decisions to minimize the accumulation of time-varying global costs. The local data may not be independent and identically distributed (i.i.d.) and the global cost functions may not be separable. Due to communication delays, neither the network center nor edge always has real-time information about the current global cost function. We propose a new framework, termed Hierarchical OCO (HiOCO), which takes full advantage of the network heterogeneity on information timeliness and computation capacity to enable multi-step estimated gradient descent at both the network center and edge.

For performance evaluation, we derive upper bounds on the dynamic regret of HiOCO, which measures the gap of costs between HiOCO and an offline global optimal performance benchmark. We show that the dynamic regret is sublinear under mild conditions. We further apply HiOCO to an online cooperative precoding design problem in multiple transmission/reception point (TRP) wireless networks with non-ideal backhaul links for 5G New Radio (NR). Simulation results demonstrate substantial performance gain of HiOCO over both the centralized and distributed alternatives.

### OCO Over Master-Worker Network

### Problem Formulation

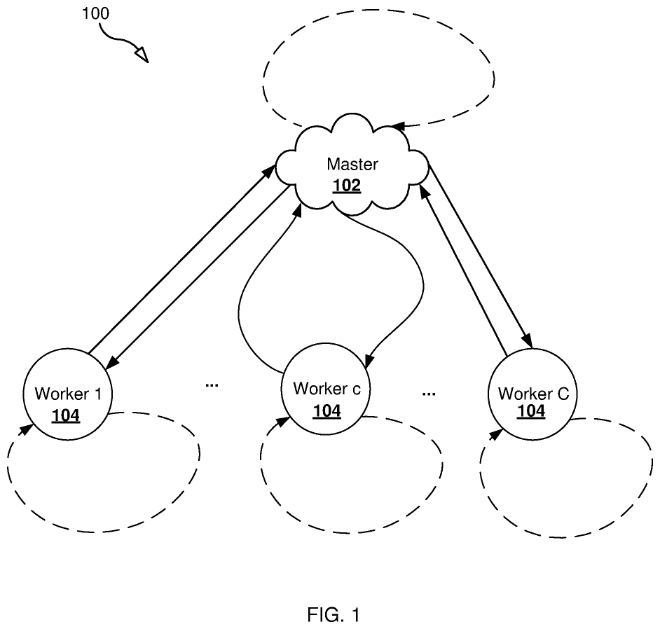

FIG. 1 illustrates an example network according to an embodiment. We consider OCO over a master—worker network 100 in a time-slotted setting with time indexed by t. As shown in FIG. 1, one master node 102 is connected to C worker nodes 104 through separate communication links. The links each have an associated delay, which is here denoted by τᵣ^{u} for the uplink delay (indicating a τᵣ^{u}-slot remote uplink delay) and for the downlink delay (indicating a τᵣ^{d}-slot remote downlink delay). The round-trip delay is at least one time slot, i.e., τᵣ=τᵣ^{u}+τᵣ^{d}≥1. For ease of exposition, we first consider the case of zero local delay, i.e., τ₁=0. Later we discuss the case of non-zero local delay. At the beginning of each time slot t, each worker node (such as a TRP) c collects a local data dₜ^{c} and executes a local decision vector xₜ^{c}∈ [symbol] ⁿ^{^{c}} from a compact convex feasible set [symbol] ^{c}∈ [symbol] ⁿ^{^{c}}. The data {dₜ^{c}}_{c=1}^{C} may be non-i.i.d. and can vary arbitrarily over time with unknown statistics.

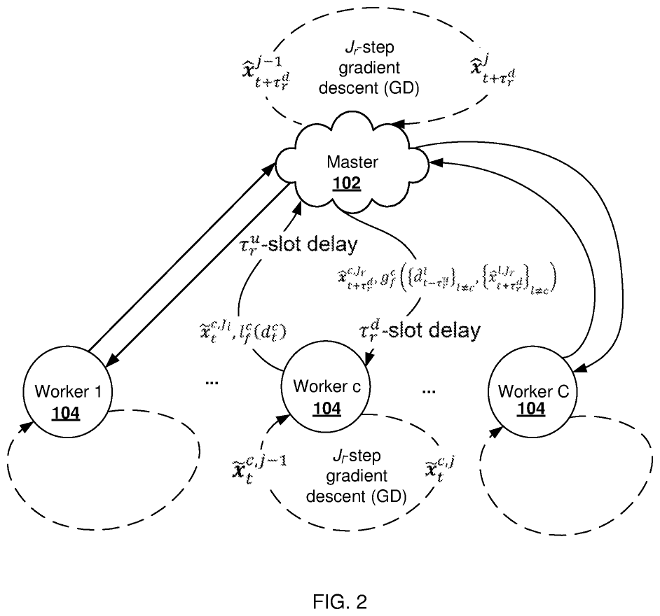

The message passing and internal node calculations described below are also illustrated schematically in FIG. 2.

Let ƒ({dₜ^{c}}_{c=1}^{C}{x^{c}}_{c=1}^{C}): [symbol] ⁿ→ [symbol] be the convex global cost function at time slot t. In the hierarchical computing network 100, the worker nodes 104 and master node 102 cooperate to jointly select a sequence of decisions from the feasible sets [symbol] ^{c}, to minimize the accumulated time-varying global costs. This leads to the following optimization problem:

$$P 1 : {min}_{{\{ {\{ {x}_{t}^{C} ∈ {𝒳}^{c} \}}_{c = 1}^{C} \}}_{t = 1}^{T}} {\sum }_{t = 1}^{T} f ( {\{ {d}_{t}^{c} \}}_{c = 1}^{C} , {\{ {x}_{t}^{c} \}}_{c = 1}^{C} ) .$$

We consider the general case that the global cost function may be non-separable among the worker nodes 103, i.e., ƒ({dₜ^{c}}_{c=1}^{C}, {x^{c}}_{c=1}^{C}) may not be expressed as the summation of C local cost functions that each corresponds only to the local data dₜ^{c} and decision vector x^{c}. Therefore, due to the coupling of both data and variables, each worker node c cannot compute the gradient ∇ₓ_{^{c}}ƒ({dₜ^{c}}_{c=1}^{C}, {x^{c}}_{c=1}^{C}) based only on its local data dₜ^{c}. In this case, the local gradient at worker node c may depend on its local data dₜ^{c}, local decision vector x^{c}, and possibly the data dₜ^{l} and decision vector xₜ^{l} at any other worker node l≠c. We define the local gradient at each worker node c as a general function denoted by h_{f}^{c} as follows:

∇ₓ^{c}ƒ({dₜ^{c}}_{c=1}^{C}, {x^{c}}_{c=1}^{C}) [symbol] h_{f}^{c}(dₜ^{c},x^{c},g_{f}^{c},({dₜ^{l}}_{l≠c},{x^{l}}_{l≠c})) (1)

where g_{f}^{c}({dₜ^{l}}_{l≠cl , {x}^{l}}_{l≠c}) is some global information function w.r.t. the local data and decision vectors at all the other worker nodes 104. The local gradient and global information functions depend on specific formats of the global cost functions. We will show later that, communicating the values of the global information functions, instead of the raw data and decision vectors, can often reduce the communication overhead.

For notation simplicity, in the following, we define the global feasible set as [symbol] [symbol] ∪_{c=1}^{C} [symbol] ^{c} and denote the global cost function ƒ({dₜ^{c}}_{c=1}^{C}, {x^{c}}_{c=1}^{C}) as ƒₜ(x), where x [symbol] [x¹^{^{T}}, . . . , x^{C}^{^{T}}]∈ [symbol] ⁿ is the global decision vector. The local gradient ∇ₓ_{^{c}}ƒ({dₜ^{c}}_{c=1}^{C}, {x^{c}}_{c=1}^{C}) at each worker node c is denoted as ∇ƒₜ^{c}(x^{c}).

### Performance Metric and Measure of Variation

Due to the lack of in-time information about the global cost function at either the worker nodes 104 or the master node 102, it is impossible to obtain an optimal solution to P1.¹ In fact, even for the most basic centralized OCO problem [3] an optimal solution cannot be found [4]. Instead, we aim at selecting an online solution sequence {xₜ}ₜ₌₁^{T} that is asymptotically no worse than the dynamic benchmark {x*ₜ}ₜ₌₁^{T}, given by

$${x}_{t}^{*} ∈ arg {min}_{x ∈ 𝒳} \{ {f}_{t} ( x ) \} . \qquad ( 2 )$$

Note that x*ₜ is computed with the current information about ƒₜ(x) at each time slot t and the resulting solution sequence {x*ₜ}ₜ₌₁^{T} is a global optimal solution to P1. The corresponding dynamic regret is defined as

RE_{T}^{d} [symbol] Σₜ₌₁^{T}(ƒₜ(xₜ)−ƒₜ(x*ₜ)). (3)

An OCO algorithm is desired to provide sublinear dynamic regret with respect to the time horizon T,

$$i . e . , lim \frac{{RE}_{T}^{d}}{T} \to 0.$$

Sublinearity is important since it implies that the online decision is asymptotically no worse than the dynamic benchmark in terms of its time-averaged performance. However, in the worst case, no online algorithm can achieve sublinear dynamic regret if the systems vary too drastically over time [40]. Therefore, the dynamic regret bounds are expressed in terms of different measures on system variations that represent the hardness of ¹ problem. For a clear comparison on the dynamic regret bounds between HiOCO and existing literature, we introduce several common variation measures as follows.

Borrowing from [3], we define the following accumulated variation of an arbitrary sequence of reference points {rₜ}ₜ₌₁^{T} (which is termed the path length in [3]):

Π_{T} [symbol] Σₜ₌₁^{T}∥rₜ−rₜ₋₁∥₂. (4)

The online projected gradient descent algorithm in [3] achieved [symbol] (\sqrt{TΠ_{T}}) dynamic regret w.r.t. any sequence of reference points {rₜ}ₜ₌₁^{T}. Another version of the path length defined in [7] is

Π′_{T} [symbol] Σₜ₌₁^{T}∥rₜ−Φₜ(rₜ₋₁∥₂. (5)

where Φₜ(⋅) is a given function available at the decision maker to predict the current reference point. The dynamic mirror descent algorithm in [7] achieved [symbol] (\sqrt{TΠ′t T}) dynamic regret. When the reference points are the optimal points, i.e., rₜ=x*ₜ for any t, the resulting path length is defined as

Π*_{T} [symbol] Σₜ₌₁^{T}∥x*ₜ−x*ₜ₋₁∥₂. (6)

There are some other related measures that can be used to characterize the system variation, e.g., the accumulated variation of the cost functions {ƒₜ(x)}ₜ₌₁^{T} given by

$${Θ}_{T} {=}^{Δ} {\sum }_{t = 1}^{T} {min}_{x ∈ 𝒳} \vert {f}_{t} ( x ) - {f}_{t - 1} ( x ) \vert \qquad ( 7 )$$

and the accumulated squared variation of gradient given by

Γ_{2,T} [symbol] Σₜ₌₁^{T}∥∇ƒₜ(xₜ)−∇ƒₜ₋₁(xₜ₋₁)∥₂² (8)

The optimistic minor descent algorithm in [8] achieved a dynamic regret bound

$$𝒪 ( min \{ \sqrt{{Γ}_{2 , T} {Π}_{T}^{★}} , {( {Γ}_{2 , T} {Θ}_{T} T )}^{\frac{1}{3}} \} )$$

in terms of Π*_{T}, Θ_{T}, and Γ_{2,T} simultaneously.

The above OCO works [3], [7], [8] focused on general convex cost functions. With strongly convex cost functions, the one-step projected gradient descent algorithm in [9]improved the dynamic regret to [symbol] (Π*_{T}). The multi-step gradient descent algorithm in [10] further improved the dynamic regret to [symbol] (Π*_{2,T}), where Π*_{2,T} is the squared path length defined as

Π*_{2,T} [symbol] Σₜ₌₁^{T}∥x*ₜ−x*ₜ₋₁∥₂². (9)

Note that if Π*_{T} or Π*_{2,T} is sublinear, Π*_{2,T} is often smaller than Π*_{T} in the order sense.² For instance ∥x*ₜ−x*ₜ₋₁|∝ [symbol] for any t, then Π*_{T}= [symbol] ( [symbol] ) and Π*_{2,T}= [symbol] ( [symbol] ). For a sublinear Π*_{T} or Π*_{2,T}, we have [symbol] <0 and therefore Π*_{2,T} is smaller than Π*_{T} in the order sense. Particularly, if

$$ϱ = - \frac{1}{2} ,$$

we have Π*_{2,T}= [symbol] (1) and Π*_{2,T}=\sqrt{T}. The standard and proximal online gradient descent algorithms were respectively extended in [11] and [12] to accommodate inexact gradient. Both resulted in [symbol] (max{Π*_{T}, Δ_{T}}) dynamic regret, where Δ_{T} is the accumulated gradient error defined as

$${Δ}_{T} {=}^{Δ} {\sum }_{t = 1}^{T} {max}_{x ∈ 𝒳} {‖ ∇ {f}_{t} ( x ) - ∇ {\hat{f}}_{t} ( x ) ‖}_{2} \qquad ( 10 )$$

with ∇\hat{ƒ}ₜ(⋅) being a given function available at the decision maker to predict the current gradient.

### Hierarchical Online Convex Optimization

In this section, we present details of HiOCO and study the impact of hierarchical multi-step estimated gradient descent on the performance guarantees of HiOCO to provide dynamic regret bounds. We further provide sufficient conditions under which HiOCO yields sublinear dynamic regrets and discuss its performance merits over existing OCO frameworks.

### HiOCO Framework

Existing distributed OCO frameworks cannot be directly applied to solve the aforementioned minimization problem with non-separable global cost functions. As an alternative, one may apply a centralized OCO approach at the master node after it has received all the local data from the worker nodes. However, this way of solving the problem does not take advantage of either the more timely information at the worker nodes or the computation ² resources at the worker nodes. Different from existing OCO frameworks that are either centralized or fully distributed, in HiOCO, the master node and worker nodes cooperate in gradient estimation and decision updates, by taking full advantage of the network heterogeneity on information timeliness and computation capacity. For ease of exposition, we will first consider the case of zero local delay at the worker node but will later extend that to the case of non-zero local delay. In the following, we present the algorithms at the master node and worker nodes.

### Master Node's Algorithm

At the beginning of each time slot t, each worker node c executes its current local decision vector xₜ^{c} and uploads it to the master node 102. To enable central gradient descent at the master node 102, each worker node c also needs to share information about the local data dₜ^{c} with the master node 102. However, sending the raw data directly would incur a large amount of uplink overhead. Instead, each worker node c sends a compression of the current local data l_{f}^{c}(dₜ^{c}) to the master node 102. Due to the remote uplink delay, at the beginning of each time slot t>τᵣ^{u}, the master node 102 only has the τᵣ^{u}-slot-delayed local decision vector x_{t-τ}_{ᵣ}_{^{u}}^{c} and compressed data set l_{f}^{c}(d_{t-τ}_{ᵣ}_{^{u}}^{c}) from each worker node c. The master node 102 then recovers an estimated data \hat{d}_{t-τ}_{ᵣ}_{^{u}}^{c} (d_{t-τ}_{ᵣ}_{^{u}}^{c}). The compression and recovery techniques on the data can be chosen based on specific applications. Note that the master node 102 needs to consider the remote downlink delay and design the decision vectors for the worker nodes τᵣ^{d}-slot ahead based on the τᵣ^{u}-slot delayed information. Only the round-trip remote delay τᵣ impacts the decision-making process. Therefore, in the following, without loss of generality, we simply consider the case with τᵣ-slot remote uplink delay and zero remote downlink delay.

Remark 1. There is often a delay—accuracy tradeoff for the recovered data

$${\{ {\hat{d}}_{t - {τ}_{r}}^{c} \}}_{c = 1}^{C}$$

at the master node, since more accurate data at the master node 102 require less compression at the worker nodes 104 and more transmission time. If data privacy is a concern, the worker nodes 104 can add noise to the compressed data while sacrificing some system performance [41].

With

$${\{ {x}_{t - {τ}_{r}}^{c} \}}_{c = 1}^{C} and {\{ {\hat{d}}_{t - {τ}_{r}}^{c} \}}_{c = 1}^{C} ,$$

for each worker node c, the master node 102 sets an intermediate decision vector \hat{x}ₜ^{c,0}=x_{t-τ}_{ᵣ}^{c} and performs Jᵣ-step gradient descent to generate \hat{x}ₜ^{c,J}^{ᵣ} as follows. For each gradient descent step j∈[1,Jᵣ] the master node 102 solves the following optimization problem for \hat{x}ₜ^{c,j}:

$$P 2 : {max}_{{x}^{c} ∈ {𝒳}^{c}} 〈 ∇ {\hat{f}}_{t - {τ}_{r}}^{c} ( {\hat{x}}_{t}^{c , j - 1} ) , {x}^{c} - {\hat{x}}_{t}^{c , j - 1} 〉 + \frac{α}{2} {‖ {x}^{c} - {\hat{x}}_{t}^{c , j - 1} ‖}_{2}^{2}$$

where ∇\hat{ƒ}_{t-τ}_{ᵣ}^{c}(\hat{x}ₜ^{c,j-1}) is an estimated gradient based on {\hat{x}ₜ^{c,j-1}}_{c=1}^{c} and

$${\{ {\hat{d}}_{t - {τ}_{r}}^{c} \}}_{c = 1}^{C} ,$$

and it is given by

$$∇ {\hat{f}}_{t - {τ}_{r}}^{c} ( {\hat{x}}_{t}^{c , j - 1} ) {=}^{Δ} {h}_{f}^{c} ( {\hat{d}}_{t - {τ}_{r}}^{c} , {\hat{x}}_{t}^{c , j - 1} , {g}_{f}^{c} ( {\{ {\hat{d}}_{t - {τ}_{r}}^{l} \}}_{l \neq c} , {\{ {\hat{x}}_{t}^{l , j - 1} \}}_{l \neq c} ) ) . \qquad ( 11 )$$

The master node 102 then sends \hat{x}ₜ^{c,J}^{ᵣ} and the corresponding global information

$${g}_{f}^{c} ( {\{ {\hat{d}}_{t - {τ}_{r}}^{l} \}}_{l \neq c} , {\{ {\hat{x}}_{t}^{l , {J}_{r}} \}}_{l \neq c} )$$

to assist the local gradient descent at each worker node c.

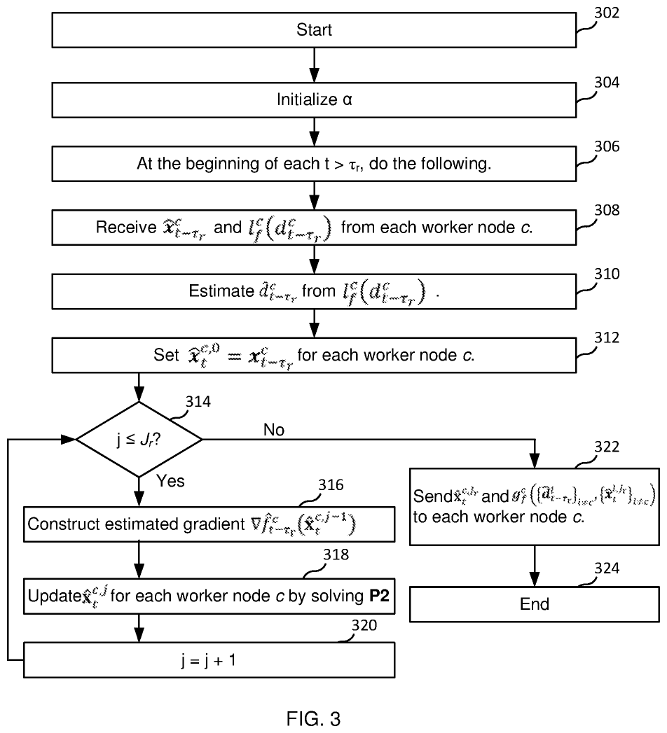

FIG. 3 illustrates an algorithm for the master node 102 according to an embodiment. At 302, the algorithm starts. At 304, the master node 102 initializes a parameter α. At 306, the master node 102 begins a time slot t, where t is greater than the remote delay τᵣ. At 308, the master node 102 receives a local decision vector (x_{t-τ}_{ᵣ}^{c}) and compressed local data (l_{f}^{c}(d_{t-τ}_{ᵣ}^{c})) from each worker node c. At 310, the master node 102 estimates the local data (d_{t-τ}_{ᵣ}^{c}) from the compressed local data (l_{ƒ}^{c}(d_{t-τ}_{ᵣ}^{c})). At 312, the master node 102 sets an intermediate decision vector \hat{x}ₜ^{c,0}=x_{t-τ}_{ᵣ}^{c} for each worker node c. At 314-320, the master node 102 performs a Jᵣ-step gradient descent to generate a global decision vector (\hat{x}ₜ^{c,J}^{ᵣ}) and corresponding global information

$$( {g}_{f}^{c} ( {\{ {\hat{d}}_{t - {τ}_{r}}^{l} \}}_{l \neq c} , {\{ {\hat{x}}_{t}^{l , j - 1} \}}_{l \neq c} ) )$$

for each worker node c.

Specifically, at 314, the master node 102 checks whether j≤Jᵣ. If it is, master node 102 proceeds to 316, otherwise master node 102 proceeds to 322. Initially, j=1 when master node 102 reaches 314 for the first time. At 316, an estimated gradient (∇\hat{ƒ}_{t-τ}_{ᵣ}^{c} (\hat{x}ₜ^{c,j-1})) is constructed according to equation 11. At 318, \hat{x}ₜ^{c,j} is updated for each worker node c by solving the optimization problem P2. At 320, the index j is incremented by one, and master node 102 proceeds to perform the check at 314. At 322, after the gradient descent has completed, master node 102 sends the global decision vector (\hat{x}ₜ^{c,J}^{ᵣ}) and corresponding global information

$$( {g}_{f}^{c} ( {\{ {\hat{d}}_{t - {τ}_{r}}^{l} \}}_{l \neq c} , {\{ {\hat{x}}_{t}^{l , {J}_{r}} \}}_{l \neq c} ) )$$

to each worker node c. At 324, the algorithm ends.
Worker Node c's Algorithm

When the global cost function is non-separable, each worker node c cannot compute the local gradient ∇ƒₜ^{c}(xₜ^{c})=h_{ƒ}^{c}(dₜ^{c},x^{c},g_{ƒ}^{c}({dₜ^{l}}_{l≠c},{x^{l}}_{l≠c})) based only on its local data dₜ^{c}. Therefore, in HiOCO, the master node 102 assists the local gradient estimation by communicating the corresponding delayed global information

$${g}_{f}^{c} ( {\{ {\hat{d}}_{t - {τ}_{r}}^{l} \}}_{l \neq c} , {\{ {\hat{x}}_{t}^{l , {J}_{r}} \}}_{l \neq c} )$$

to each worker node c. Note that due to the communication delay and data compression, the global information received by the worker nodes 104 is delayed and with errors.

At the beginning of each time slot t>τᵣ, each worker node c receives the global decision vector \hat{x}ₜ^{c,J}^{ᵣ} and the global information

$${g}_{f}^{c} ( {\{ {\hat{d}}_{t - {τ}_{r}}^{l} \}}_{l \neq c} , {\{ {\hat{x}}_{t}^{l , {J}_{r}} \}}_{l \neq c} )$$

from the master node 102. Each worker node c then sets an intermediate decision vector \tilde{x}ₜ^{c,0}=\hat{x}ₜ^{c,J}^{ᵣ} and performs a J₁-step gradient descent to generate \tilde{x}ₜ^{c,J}^{₁} as follows. For each gradient descent step j∈[1,J₁], each worker node c solves the following optimization problem for \tilde{x}ₜ^{c,j}

$$P 3 : {min}_{{x}^{c} ∈ {X}^{c}} 〈 ∇ {\hat{{f}_{t}}}^{c} ( {\tilde{x}}_{t}^{c , j - 1} ) , {x}^{c} - {\tilde{x}}_{t}^{c , j - 1} 〉 + \frac{α}{2} {‖ {x}^{c} - {\tilde{x}}_{t}^{c , j - 1} ‖}_{2}^{2}$$

where ∇\hat{ƒ}ₜ^{c} (\tilde{x}ₜ^{c,j-1}) is an estimated gradient based on the timely local data dₜ^{c} and the delayed global information

$${g}_{f}^{c} ( {\{ {\hat{d}}_{t - {τ}_{r}}^{l} \}}_{l \neq c} , {\{ {\hat{x}}_{t}^{l , {J}_{r}} \}}_{l \neq c} ) ,$$

and it is given by

$$∇ {\hat{f}}_{t}^{c} ( {\tilde{x}}_{t}^{c , j - 1} ) {=}^{Δ} {h}_{f}^{c} ( {d}_{t}^{c} , {\tilde{x}}_{t}^{c , j - 1} , {g}_{f}^{c} ( {\{ {\hat{d}}_{t - {τ}_{r}}^{l} \}}_{l \neq c} , {\{ {\hat{x}}_{t}^{l , {J}_{r}} \}}_{l \neq c} ) ) . \qquad ( 12 )$$

The above estimated gradient takes full advantage of the information timeliness at the worker nodes, as well as the central availability of information at the master node, to enable local gradient descent at the worker nodes for non-separable cost functions. Each worker node c then executes xₜ^{c}=\tilde{x}ₜ^{c,J}^{₁} as its current local decision vector. It then uploads xₜ^{c} and the compressed local data l_{ƒ}^{c}(dₜ^{c}) to the master node.

Remark 2. For separable global cost functions, HiOCO can still be applied. In this case, it is still beneficial to perform centralized gradient descent for improved system performance, while sacrificing some communication overhead caused by uploading the compressed local data.

Remark 3. Single-step and multi-step gradient descent algorithms were provided in [9] and [10], while [11] and [12] proposed single-step inexact gradient descent algorithms. However, the algorithms in [9], [10], [11], [12] are centralized and under the standard OCO setting with one-slot delayed gradient information. In HiOCO, both the master node 102 and worker nodes 104 can perform multi-step estimated gradient descent in the presence of multi-slot delay.

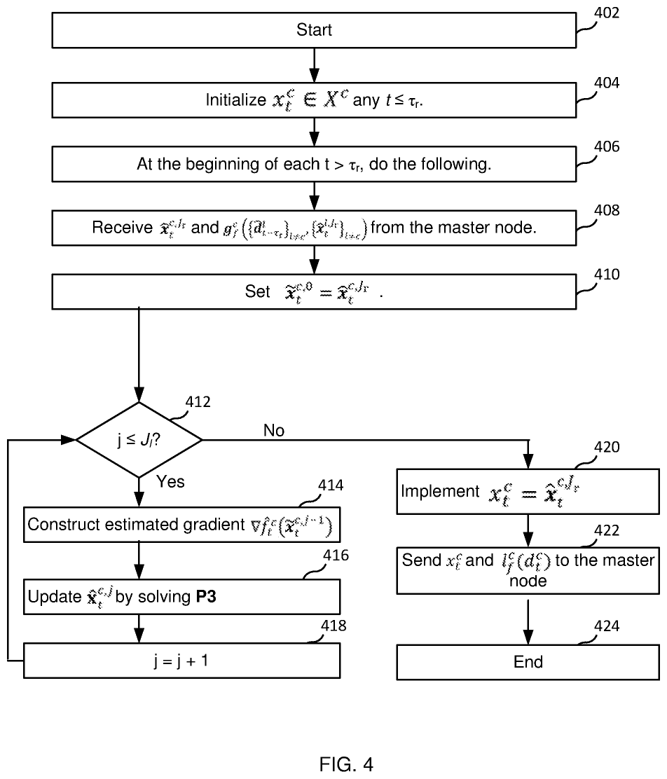

FIG. 4 illustrates an algorithm for the worker node 104 according to an embodiment. At 402, the algorithm starts. At 404, the worker node 104 initializes local decision vectors (xₜ^{c} for xₜ^{c}∈ [symbol] ^{c}) for any t≤τᵣ. At 406, the worker node 104 begins a time slot t, where t is greater than the remote delay τᵣ. At 408, the worker node 104 receives a global decision vector (\hat{x}ₜ^{c,J}^{ᵣ}) and global information

$$( {g}_{f}^{c} ( {\{ {\hat{d}}_{t - {τ}_{r}}^{l} \}}_{l \neq c} , {\{ {\hat{x}}_{t}^{l , {J}_{r}} \}}_{l \neq c} ) )$$

from the master node 102. At 410, the worker node 104 sets an intermediate decision vector \tilde{x}ₜ^{c,0}=\hat{x}ₜ^{c,J}^{ᵣ}. At 412-418, the worker node 104 performs a J₁-step gradient descent to generate a local decision vector (\tilde{x}ₜ^{c,J}^{₁}).

Specifically, at 412, the worker node 104 checks whether j≤J₁. If it is, worker node 104 proceeds to 414, otherwise worker node 104 proceeds to 420. Initially, j=1 when worker node 104 reaches 412 for the first time. At 414, an estimated gradient (∇\hat{ƒ}ₜ^{c}(\tilde{x}ₜ^{c,j-1}) is constructed according to equation 12. At 416, \tilde{x}ₜ^{c,j} is updated by solving the optimization problem P3. At 418, the index j is incremented by one, and worker node 104 proceeds to perform the check at 412. At 420, after the gradient descent has completed, worker node 104 implements xₜ^{c}=\hat{x}ₜ^{c,J}^{ᵣ} as its current local decision vector. At 422, worker node 104 sends the local decision vector (xₜ^{c}) and corresponding compressed local data (l_{f}^{c}(dₜ^{c}) to the master node 102. At 424, the algorithm ends.

### Dynamic Regret Bounds

In this section, we present new techniques to derive the dynamic regret bounds of HiOCO, particularly to account for its hierarchical multi-step estimated gradient descent with multi-slot delay. For clarity of exposition, proofs are omitted.

We make the following assumptions that are common in the literature of OCO with strongly convex functions [9], [10], [11], [12]. Strongly convex objectives arise in many machine learning and signal processing applications, such as Lasso regression, support vector machines, and robust subspace tracking. For applications with general convex cost functions, adding a simple regularization term like

$$\frac{μ}{2} {‖ x ‖}_{2}^{2}$$

often does not sacrifice the system performance We will show later that strongly convexity develops a contraction relation between ∥xₜ₊₁-x*ₜ∥₂² and ∥xₜ−x*ₜ∥₂² which can be leveraged to improve the dynamic regret bounds.

Assumption 1. For any t, ƒₜ(x) satisfies the following:

ƒₜ(x) is μ-strongly convex over [symbol] , i.e., ∃μ>0, s.t., for any x, y∈ [symbol] and t

$${f}_{t} ( y ) \geq {f}_{t} ( x ) + 〈 ∇ {f}_{t} ( x ) , y - x 〉 + \frac{μ}{2} {‖ y - x ‖}_{2}^{2} . \qquad ( 13 )$$

ƒₜ(x) is L-smooth over [symbol] , i.e., ∃L>0, s.t., for any x, y∈ [symbol] and t

$${f}_{t} ( y ) \leq {f}_{t} ( x ) + 〈 ∇ {f}_{t} ( x ) , y - x 〉 + \frac{L}{2} {‖ y - x ‖}_{2}^{2} . \qquad ( 14 )$$

The gradient of ƒₜ(x) is bounded, i.e., ∃D>0, s.t., for any x∈ [symbol] and t

∥∇ƒₜ(x)∥₂≤D. (15)

Assumption 2. The radius of [symbol] is bounded, i.e., ∃R>0, s.t., for any x, y∈z,ϵ

∥x−y∥₂≤R. (16)

We also require the following lemma, which is reproduced from Lemma 2.8 in [1].

Lemma 1. Let ,ϵ∈ [symbol] ⁿ be a nonempty convex set. Let ƒ(x) be a μ-strongly-convex function over z,68 . Let

$${x}^{⋆} ∈ arg {min}_{x ∈ X} \{ f ( x ) \} .$$

Then, for any y∈ [symbol] , we have

$$f ( {x}^{⋆} ) \leq f ( y ) - \frac{μ}{2} {‖ y - {x}^{⋆} ‖}_{2}^{2} .$$

The following lemma is general and quantifies the impact of one-step estimated gradient descent in terms of the squared gradient estimation error. We further provide a sufficient condition under which the estimated gradient descent yields an improved decision to the optimal points.

Lemma 2. Assume ƒ(x): [symbol] → [symbol] is μ-strongly-convex and L-smooth. Let

$$z ∈ arg {min}_{x ∈ X} \{ 〈 ∇ \hat{f} ( y ) , x - y 〉 + \frac{α}{2} {‖ x - y ‖}_{2}^{2} \} ,$$

where ∇\hat{ƒ}(y) is an estimated gradient of ∇ƒ(y), and

$${x}^{★} ∈ arg {min}_{x ∈ X} \{ f ( x ) \} .$$

For any α>L, and γ∈(0, 2μ), we have

$${‖ z - {x}^{★} ‖}_{2}^{2} \leq η {‖ y - {x}^{★} ‖}_{2}^{2} + β {‖ ∇ \hat{f} ( y ) - ∇ f ( y ) ‖}_{2}^{2} \qquad ( 17 )$$

$$where η = \frac{α - μ}{α + μ - γ} < 1 and β = \frac{1}{γ ( α + μ - γ )} .$$

The sufficient condition for ∥z−x*∥₂²<∥y−x∥₂² is

∥∇\hat{ƒ}(y)−∇ƒ(y)∥₂²<γ(2μ−γ)∥y−x*∥₂². (18)

Remark 4. The condition on gradient estimation error in (18) is most easily satisfied when γ=μ. In this case, the contraction constant

$$η = \frac{α - μ}{α}$$

recovers the one in [9]. Furthermore, as γ approaches 0, η approaches the contraction constant

$$\frac{α - μ}{α + μ}$$

in [10]. Different from Proposition 2 in [9] and Lemma 5 in [10], Lemma 2 takes into account the impacts of estimated gradient descent and generalizes the results in [9] and [10].

Remark 5. The optimal gradient descent step-size in needs to be in a specific range based on the knowledge of μ, L and v from an additional assumption ∥∇\hat{ƒ}ₜ(xₜ)−∇ƒₜ(xₜ)∥₂²≤ϵ²+υ²∥∇ƒₜ(xₜ)∥₂² for some ϵ≥0 and υ≥0. The contraction analysis in [12] focused on the proximal point algorithm and is substantially different from Lemma 2.

We examine the impact of hierarchical multi-step estimated gradient descent on the dynamic regret bounds for OCO, which has not been addressed in the existing literature. To this end, we define the accumulated squared gradient error as

$${Δ}_{2 , T} {=}^{△} {\sum }_{t = 1}^{T} {max}_{x ∈ X} {‖ ∇ {f}_{t} ( x ) - ∇ {\hat{f}}_{t} ( x ) ‖}_{2}^{2} \qquad ( 19 )$$

Similar to the relationship between the standard path length Π*_{T}, and squared path length Π*_{2,T} as discussed above, Δ_{2,T} is often smaller than Δ_{T} in the order sense. Note that

$${max}_{x ∈ X} {‖ ∇ {f}_{t} ( x ) - ∇ {\hat{f}}_{t} ( x ) ‖}_{2}$$

in (19) is the maximum estimated gradient estimation error and serves as an upper bound for the gradient estimations in (11) and (12). We use Δ_{2,T} as a loose upper bound for our performance analysis since it covers more general gradient estimation schemes that can be adopted in HiOCO.

Leveraging results in Lemmas 1-2 and OCO techniques, the following theorem provides upper bounds on the dynamic regret RE_{T}^{d} for HiOCO.

Theorem 3. For any α≥L, ξ>0 and γ∈(0, 2μ), the dynamic regret yielded by HiOCO is bounded as follows:

For any J₁+Jᵣ≥1 such that 2η^{J}^{₁}^{+J}^{ᵣ}≤1, we have

$$R {E}_{T}^{d} \leq \frac{1}{2 ξ} {\sum }_{t = 1}^{T} {‖ ∇ {f}_{t} ( {x}_{t}^{★} ) ‖}_{2}^{2} + \frac{L + ξ}{2} {τ}_{r} {R}^{2} + \frac{L + ξ}{2 ( 1 - 2 {η}^{{J}_{l} + {J}_{r}} )} ( {τ}_{r} {R}^{2} + 2 {τ}_{r}^{2} {Π}_{2 , T}^{★} + \frac{2 β}{1 - η} {Δ}_{2 , T} ) .$$

For any J₁+Jᵣ≥1, we have

$$R {E}_{T}^{d} \leq {τ}_{r} D R + \frac{D}{1 - \sqrt{{η}^{{J}_{l} + {J}_{r}}}} ( {τ}_{r} {R}^{2} + {τ}_{r} {Π}_{T}^{★} + \frac{\sqrt{β}}{1 - \sqrt{η}} {Δ}_{T} ) .$$

Extension with Local Delay

We now consider the case of non-zero local delay, i.e., at the beginning of each time slot t, each worker node c only has τ₁-delayed local data d_{t-τ}_{₁}^{c} for some τ₁≥1. In this case, we modify the master and worker algorithms by adding τ₁-slot delay to the algorithm starting time and all the time stamps of the data and estimated gradients. Let τ=τ₁+τᵣ be the total delay. Noting that the master node only has T-slot delayed data {\hat{d}_{t-τ}^{c}}_{c=1}^{C}, with compression errors for gradient estimation at the beginning of each time slot t>τ.

The master node's algorithm with local delay may proceed as follows. The algorithm starts, the parameter a is initialized, and at the beginning of each t>τ, the master node 102 receives x_{t-τ}_{ᵣ}^{c} and l_{ƒ}^{c}(d_{t-τ}^{c}) from each worker node c. The master node 102 estimates \hat{d}_{t-τ}^{c} from l_{ƒ}^{c}(d_{t-τ}^{c}). The master node 102 sets \hat{x}ₜ^{c,0}=x_{t-τ}^{c} for each worker node c. For each step j of the Jᵣ-step gradient descent, the gradient ∇\hat{ƒ}_{t-τ}^{c}(\hat{x}ₜ^{c,j-1}) is constructed. This is done similarly to what is shown in equation 11, noting that the time stamps are adjusted to account for the local delay. Likewise, for each step j of the Jᵣ-step gradient descent, \hat{x}ₜ^{c,j} is updated for each worker node c by solving P2 with ∇\hat{ƒ}_{t-τ}^{c}(\hat{x}ₜ^{c,j-1}). Following the gradient descent, \hat{x}ₜ^{c,J}^{ᵣ} and g_{ƒ}^{c}({\hat{d}ₜ^{l}}_{l≠c}, {\hat{x}^{l}}_{l≠c}) are sent to the worker nodes c.

The worker node's algorithm with local delay may proceed as follows. The algorithm starts, the local decision vectors xₜ^{c}∈ [symbol] ^{c} for any t≤τ are initialized, and at the beginning of each t>τ, the worker node 104 receives \hat{x}ₜ^{c,J}^{ᵣ} and g_{ƒ}^{c}({\hat{d}ₜ^{l}}_{l≠c}, {\hat{x}^{l}}_{l≠c}) from the master node 102. The worker node 104 sets \tilde{x}ₜ^{c,0}=\hat{x}ₜ^{c,J}^{ᵣ}. For each step j of the J₁-step gradient descent, the gradient ∇\hat{ƒ}_{t-τ}_{₁}^{c}(\tilde{x}ₜ^{c,j-1}) is constructed. This is done similarly to what is shown in equation 12, noting that the time stamps are adjusted to account for the local delay. Likewise, for each step j of the J₁-step gradient descent, \tilde{x}ₜ^{c,j} is updated by solving P3 with ∇\hat{ƒ}_{t-τ}_{₁}^{c}(\tilde{x}ₜ^{c,j-1}). Following the gradient descent, is xₜ^{c}=\hat{x}ₜ^{c,J}^{ᵣ} implemented as the local decision vector, and xₜ^{c} and l_{ƒ}^{c}(d_{t-τ}_{₁}^{c}) are sent to the master node 102.

Using similar techniques in the proof of Theorem 3, we provide dynamic regret bounds for HiOCO in the presence of both local and remote delay.

Theorem 4. For any α≥L, ξ>0 and γ∈(0, 2μ), the dynamic regret yielded by HiOCO is bounded as follows:

For any J₁+Jᵣ≥1 such that 4η^{J}^{₁}^{+J}^{ᵣ}<1, we have

$$R {E}_{T}^{d} \leq \frac{1}{2 ξ} {\sum }_{t = 1}^{T} {‖ ∇ {f}_{t} ( {x}_{t}^{★} ) ‖}_{2}^{2} + \frac{L + ξ}{2} τ {R}^{2} + \frac{L + ξ}{2 ( 1 - 4 {η}^{{J}_{l} + {J}_{r}} )} ( τ {R}^{2} + ( 2 {τ}_{l}^{2} + 4 {τ}_{r}^{2} ) {Π}_{2 , T}^{★} + \frac{2 β}{1 - η} {Δ}_{2 , T} ) .$$

For any J₁+Jᵣ≥1, we have

$$R {E}_{T}^{d} \leq τ D R + \frac{D}{1 - \sqrt{{η}^{{J}_{l} + {J}_{r}}}} ( τ {R}^{2} + τ {Π}_{T}^{★} + \frac{\sqrt{β}}{1 - \sqrt{η}} {Δ}_{T} ) .$$

Due to the local delay, Theorem 4 has a more stringent condition on the total number of gradient descent steps compared with Theorem 3. However, the order of the dynamic regret bound is dominated by the accumulated system variation measures and is often the same as the case without local delay.

### Discussion on the Dynamic Regret Bounds

In this section, we discuss the sufficient conditions for HiOCO to yield sublinear dynamic regret and highlight several prominent advantages of HiOCO over existing OCO frameworks. From Theorems 3 and 4, we can derive the following corollary regarding the dynamic regret bound.

Corollary 5. Suppose the accumulated squared variation of the gradient at the optimal points satisfies Σₜ₌₁^{T}∥∇ƒₜ(x*ₜ)∥₂²= [symbol] (max{τ² Π*_{2,T}, Δ_{2,T}}), from Theorems 3 and 4, we have

RE_{T}^{d}= [symbol] (min{max{τΠ*_{T},Δ_{T}},max{τ²Π*_{2,T},Δ_{2,T}}}).

Note that Σₜ₌₁^{T}∥∇ƒₜ(x*ₜ)∥₂² is often small and the condition in Corollary 5 is commonly satisfied. In particular, if x*ₜ is an interior point of [symbol] or P1 is an unconstrained online problem, we have ∇ƒₜ(x*ₜ)=0. Form Corollary 5, a sufficient condition for HiOCO to yield sublinear dynamic regret is either max{τΠ*_{T},Δ_{T}}=o(T) or max{τ²Π*_{2,T},Δ_{2,T}}=o(T). Sublinearity of the accumulated system measures is necessary to have sublinear dynamic regret [40]. In many online applications, the system tends to stabilize and the gradient estimation becomes more accurate over time, leading to sublinear dynamic regret.

Remark 6. The centralized single-step and multi-step gradient descent algorithms achieved [symbol] (Π*_{T}) and (min{Π*_{T},Π*_{2,T}}) dynamic regrets in [9] and [10], respectively. HiOCO takes advantage of both the timely local and delayed global information to perform multi-step estimated gradient descent at both the master and worker nodes. Our dynamic regret bound analysis takes into account the impacts of the unique hierarchical update architecture, gradient estimation errors, and multi-slot delay on the performance guarantees of OCO that were not considered in [9] and [10].

Remark 7. The centralized single-step inexact gradient descent algorithms in [11] and [12] achieved [symbol] (max{Π*_{T}, Δ_{T}}) dynamic regret under the standard OCO setting with one-slot delay. Noting that in the order sense, Π*_{2,T} and Δ_{2,T} are usually smaller than Π*_{T} and Δ_{T}, respectively. Therefore, even in the presence of multi-slot delay, HiOCO provides a better dynamic regret bound by increasing the number of estimated gradient descent steps, and recovers the performance bounds in [11] and [12] and as a special case.

### Application to Multi-TRP Cooperative Wireless Networks

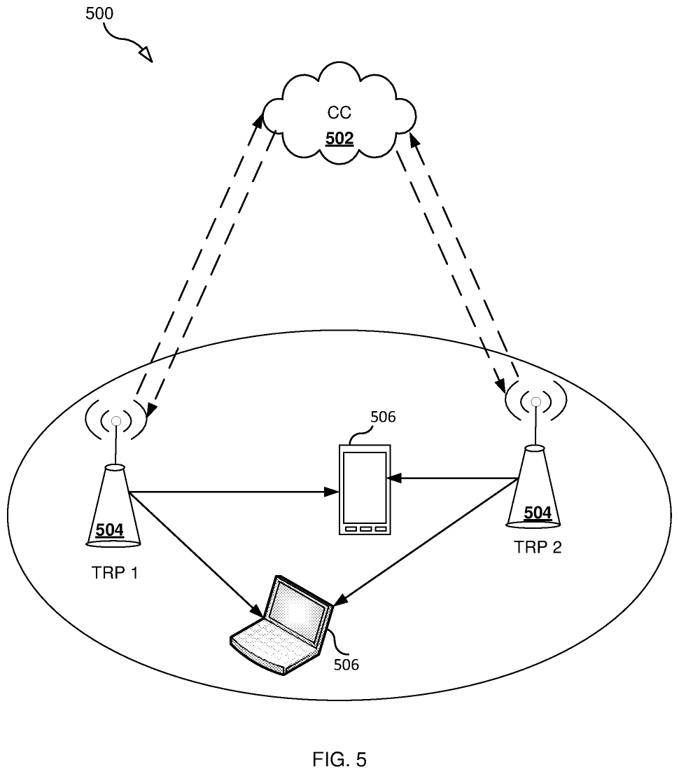

FIG. 5 illustrates an example application according to an embodiment. We apply HiOCO to solve an online multi-TRP cooperative precoding design problem in multiple-input multiple-output (MIMO) systems, where multiple TRPs 504 (such as TRP 1 and TRP 2 that are illustrated) jointly transmit signals to serve users 506 in the network 500 as shown in FIG. 5. The TRPs 504 also cooperate with the CC 502. Traditional cooperative precoding design schemes focused on centralized offline problems at the CC with instantaneous CSI [37], [38], [39]. In contrast, some disclosed embodiments provided here are online, based on delayed CSI, and updated at both the CC 502 and TRPs 504.

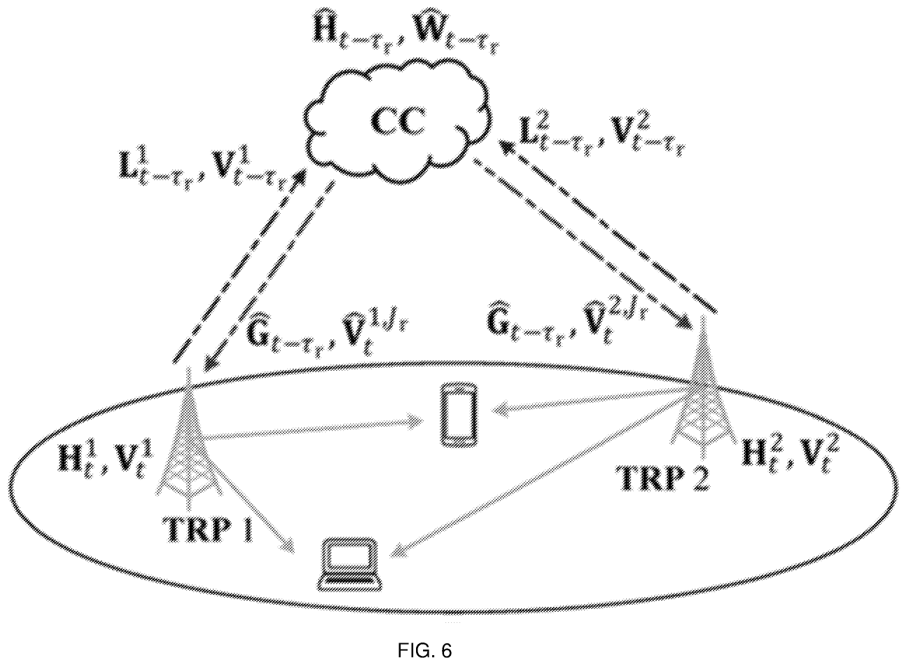

The message passing and internal node calculations described below are also illustrated schematically in FIG. 6.

### Online Multi-TRP Cooperative Precoding Design

We consider a total of C TRPs 504 coordinated by the CC 502 to jointly serve K users 506 in the cooperative network 500. Each TRP c has N^{c} antennas, so there is a total of N=Σ_{c=1}^{C}N^{c} antennas in the network 500. Let Hₜ^{c}∈ [symbol] ^{K×N}^{^{c}} denote the local channel state of the K users 506 from TRP c. Let Hₜ^{c}=[Hₜ¹, . . . , Hₜ^{C}]∈ [symbol] ^{K×N} denote the global channel state between the K users 506 and C TRPs 504.

For ease of illustration only, here we consider the case where there is no local delay at the TRPs to collect the local CSI. However, embodiments may also cover the case of non-zero local delay as explained above. At each time slot t, each TRP c has the current local CSI Hₜ^{c} and implements a local precoding matrix Vₜ^{c}∈ [symbol] ^{N}^{^{c}}^{×K} (in the compact convex set

[symbol]

^{c} [symbol] {V^{c}:∥V^{c}∥_{F}²≤Pₘₐₓ^{c}} (20)

to meet the per-slot maximum transmit power limit. Let Vₜ=[Vₜ¹^{^{H}}, . . . , Vₜ^{c}^{^{H}}]∈ [symbol] ^{N×K} denote the global precoding matrix executed by the C TRPs 504 at time slot t. The actual received signal vector yₜ (excluding noise) at the K users 506 is given by

yₜ=HₜVₜsₜ

where sₜ∈ [symbol] ^{K×1} contains the transmitted signals from the TRPs to all K users 506 which are assumed to be independent to each other with unit power, i.e., [symbol] {sₜsₜ^{H}}=I, ∀t.

We first consider idealized backhaul communication links, where each TRP c communicates Hₜ^{c} to the CC 502 without delay. The CC 502 then has the global CSI Hₜ at time slot t and designs a desired global precoder Wₜ∈ [symbol] ^{N×K} to meet the per-TRP maximum power limits. The design of Wₜ can be based on the services needs of the K users 506 and is not limited to any specific precoding scheme. For the CC 502 with Wₜ, the desired received signal vector (noiseless) \tilde{y}ₜ is given by

\tilde{y}ₜ=HₜWₜsₜ.

With the TRPs' 504 actual precoding matrix Vₜ and the desired precoder Wₜ at the CC 502, the expected deviation of the actual received signal vector at all K users 506 from the desired one is given by [symbol] {∥yₜ−\tilde{y}ₜ∥_{F}²}=∥HₜVₜ−HₜWₜ∥_{F}². We define the precoding deviation of the TRPs' 504 precoding from the precoder at the CC 502 as

ƒₜ(V) [symbol] ∥HₜVₜ−HₜWₜ∥_{F}²,∀t (21)

which is a strongly convex cost function.

Note that due to the coupling of local channel states {Hₜ^{c}}_{c=1}^{C} and local precoders {Vₜ^{c}}_{c=1}^{C}, the cost function ƒₜ(V) is not separable among the TRPs 504. Furthermore, the local gradient at each TRP c depends on the local channel state W, local precoder W, and the channel states {Hₜ^{l}}_{l≠c} and precoders {Vₜ^{l}}_{l≠c} at all the other TRPs 504, given by

$$∇ {f}_{t}^{c} ( V ) {=}^{△} \frac{\partial {f}_{t} ( V )}{\partial {V}^{{c}^{*}}} = {H}_{t}^{c} ( {\sum }_{l = 1}^{C} ( {H}_{t}^{l} {V}^{l} ) - {H}_{t} {W}_{t} ) .$$

The goal of the multi-TRP cooperative network 500 is to minimize the accumulation of the precoding deviation subject to per-TRP maximum transmit power limits with non-ideal backhaul communication links. The online optimization problem is in the same form as P1 with {Hₜ^{c}}_{c=1}^{C} being the local data, {Vₜ^{c}∈ [symbol] ^{c}}_{c=1}^{C} being the local decision vectors, and ƒₜ(V) being the global cost function.

For non-ideal backhaul links with τᵣ^{u}-slot uplink and τᵣ^{d}-slot downlink communication delays, as illustrated herein, only the round-trip communication delay τᵣ matters and we can equivalently consider there is τᵣ-slot uplink delay and no downlink delay. At each time slot t, each TRP c has the timely local CSI Hₜ^{c} and implements a local precoder Vₜ^{c}. If communication overhead is a concern, instead of sending the complete CSI Hₜ^{c}, each TRP c can send a compressed local CSI Lₜ^{c} to the CC 502. Due to the communication delay and CSI compression, the CC 502 recovers a delayed global channel state Ĥ_{t-τ}_{ᵣ}, with errors, and then it designs the desired precoding matrix Ŵ_{t-τ}_{ᵣ}. Later we will show how HiOCO leverages the instantaneous local CSI {Hₜ^{c}}_{c=1}^{C} at the TRPs 504 and the delayed global channel state Ĥ_{t-τ}_{ᵣ}, at the CC 502 to jointly design the cooperative precoding matrices {Vₜ^{c}}_{c=1}^{C}.

### Hierarchical Precoding Solution

Leveraging the proposed HiOCO framework, we now provide hierarchical solutions to the formulated online multi-TRP cooperative precoding design problem.

### Precoding Solution at CC

At the beginning of each time slot t>τᵣ, the CC 502 receives the precoding matrices

$${\{ {V}_{t - {τ}_{r}}^{c} \}}_{c = 1}^{C}$$

from the TRPs 504 and recovers the delayed global CSI Ĥ_{t-τ}_{ᵣ} with some errors from the compressed local

$$CSI {\{ {L}_{t - {τ}_{r}}^{c} \}}_{c = 1}^{C} .$$

It then sets \hat{V}ₜ^{c,0}=V_{t-τ}_{ᵣ}^{c} for each TRP c and performs Jᵣ-step estimated gradient descent to generate \hat{V}ₜ^{c,J}^{ᵣ}. For each gradient descent step j∈[1,Jᵣ], the CC 502 has a closed-form precoding solution given by

$${\hat{V}}_{t}^{c , j} = {𝒫}_{{𝒱}^{c}} \{ {\hat{V}}_{t}^{c , j - 1} - \frac{1}{α} ∇ {\hat{f}}_{t - {τ}_{r}}^{c} ( {\hat{V}}_{t}^{c , j - 1} ) \}$$

where

$${𝒫}_{{𝒱}^{c}} \{ {V}^{c} \} = arg {min}_{{U}^{c} ∈ {𝒱}^{c}} \{ {‖ {U}^{c} - {V}^{c} ‖}_{F}^{2} \}$$

is the projection operator onto the convex feasible set [symbol] ^{c} and

$$∇ {\hat{f}}_{t - {τ}_{r}}^{c} ( {\hat{V}}_{t}^{c , j - 1} ) = {\hat{H}}_{t - {τ}_{r}}^{c} ( {\sum }_{l = 1}^{C} ( {\hat{H}}_{t - {τ}_{r}}^{l} {\hat{V}}_{t}^{l , j - 1} ) - {\hat{H}}_{t - {τ}_{r}} {\hat{W}}_{t - {τ}_{r}} )$$

is an estimation of the gradient at time slot t−τᵣ. The CC 502 then communicates the intermediate precoder \hat{V}ₜ^{c,J}^{ᵣ} and global information Ĝ_{t-τ}^{c}=Σ_{t=1, l≠c}^{C}(Ĥ_{t-τ}_{ᵣ}^{l}\hat{V}ₜ^{l,J}^{ᵣ})−Ĥ_{t-τ}_{ᵣ}Ŵ_{t-τ}_{ᵣ}∈ [symbol] ^{K×K} to TRP c, for all c∈{1, . . . C}. Note that there is no need to communicate the local information Ĥ_{t-τ}_{ᵣ}^{c}\hat{V}ₜ^{c,J}^{ᵣ} to each TRP c, since more recent local information will be used to reduce the gradient estimation error.

Note that instead of sending the global channel state Ĥ_{t-τ}_{ᵣ}∈ [symbol] ^{K×N} global precoding matrix \hat{V}ₜ^{J}^{ᵣ}∈ [symbol] ^{N×K} and the desired global precoder Ŵ_{t-τ}_{ᵣ}∈C^{N×K} to each TRP c for the local gradient estimation, in the proposed method, sending Vₜ^{c,J}^{ᵣ}∈ [symbol] ^{N}^{^{c}}^{×K} and Ĝ_{t-τ}_{ᵣ}^{c}∈ [symbol] ^{K×K} to each TRP c greatly reduces the amount of downlink communication overhead.

### Precoding Solution at TRP c

Each TRP c can implement any local precoder in [symbol] ^{c} for any t∈[1, τᵣ]. At the beginning of each time slot t>τᵣ, after receiving the intermediate precoder \hat{V}ₜ^{c,J}^{ᵣ} and global information Ĝ_{t-τ}^{c} from the CC 502, each TRP c sets \tilde{V}ₜ^{c,0}=\hat{V}ₜ^{c,J}^{ᵣ} and performs J₁-step estimated gradient descent to generate \tilde{V}ₜ^{c,J}^{₁}. For each gradient descent step j∈[1, J₁], each TRP c also has a closed-form precoding solution given by

$${\tilde{V}}_{t}^{c , j} = {𝒫}_{{𝒱}^{c}} \{ {\tilde{V}}_{t}^{c , j - 1} - \frac{1}{α} ∇ {\hat{f}}_{t}^{c} ( {\tilde{V}}_{t}^{c , j - 1} ) \}$$

$$where ∇ {\hat{f}}_{t}^{c} ( {\tilde{V}}_{t}^{c , j - 1} ) = {H}_{t}^{c} ( {H}_{t}^{c} {\tilde{V}}_{t}^{c , j - 1} + {\hat{G}}_{t - τ}^{c} )$$

is an estimation of the current gradient based on the timely local CSI Hₜ^{c} and delayed global information Ĝ_{t-τ}^{c}. Finally, each TRP c uses Vₜ^{c}=\tilde{V}ₜ^{c,J}^{₁} as its precoding matrix for transmission in time slot t and communicates it together with either the complete CSI Hₜ^{c} or the compressed local CSI Lₜ^{c} to the CC 502.

### Performance Bounds

Note that the optimal precoding solution is V*ₜ=Wₜ at each time slot t. However, with non-ideal backhaul links, each TRP c cannot receive Vₜ^{c}* from the CC 502 in time and implement it at each time slot t. A naive solution is to implement the delayed optimal solution V*_{t-τ}_{ᵣ}, at the TRPs 504. However, we will show that directly implementing V*_{t-τ}_{ᵣ}, at the TRPs 504 leads to system performance degradation compared with HiOCO can adopt to the unknown channel variations.

We assume that the channel power is bounded by a constant B>0 at any time t, given by

∥Hₜ∥_{F}²≤B. (23)

In the following Lemma, we show that the formulated online multi-TRP cooperative precoding design problem satisfies Assumptions 1 and 2 made above.

Lemma 6. Assume the channel power is bounded in (23). Then, Assumptions 1 and 2 hold with the corresponding constants given by μ=2, L=B, D=2B\sqrt{Σ_{c=1}^{C}Pₘₐₓ^{c}}, and R=2\sqrt{Σ_{c=1}^{C}Pₘₐₓ^{c}}.

Leveraging the results in Theorems 3 and 4, and noting that the gradient of the optimal precoder satisfies ∇^{t}(V*ₜ)=Hₜ^{H}/(HₜV*ₜ−HₜWₜ)=0, the following corollary provides the dynamic regret bounds yielded by the hierarchical online precoding solution sequence {Vₜ}ₜ₌₁^{T}.

Corollary 7. The dynamic regret bounds in Theorems 3 and 4 hold for {Vₜ}ₜ₌₁^{T} generated by HiOCO, with the constants μ, L, D, and R given in Lemma 6 and Σₜ₌₁^{T}∥∇ƒₜ(V*ₜ)∥_{F}²=0.

### Simulation Results

In this section, we present simulation results under typical urban micro-cell LTE network settings. We study the impact of various system parameters on the convergence and performance of HiOCO. We numerically demonstrate the performance advantage of HiOCO over both the centralized and distributed alternatives.

### Simulation Setup

We consider an urban hexagon micro-cell of radius 500 m with C=3 equally separated TRPs each is equipped with N^{c}=16 antennas. We consider 5 co-located users in the middle of every two adjacent TRPs for a total of K=15 users in the network. Following the standard LTE specification [42], as default system parameters, we set maximum transmit power limit Pₘₐₓ^{c}=30 dBm, noise power spectral density N₀=−174 dBm/Hz, noise figure N_{F}=10 dB, and we focus on the channel over one subcarrier with bandwidth B_{W}=15 kHz. We model the fading channel as a first order Gauss Markov process hₜ₊₁^{c,k}+αₕhₜ^{c,k}+zₜ^{c,k} between each user k and each TRP c, where hₜ^{c,k}˜ [symbol] (0, β^{c,k}I) with β^{c,k} [dB]=−31.54-33 log₁₀ (d_{c,k})−φ^{c,k} represents the path-lost and shadowing effects, d^{c,k} being the distance in kilometers from TRP c to user k, φ^{c,k}˜ [symbol] (0,σ_{Ø}²) being the shadowing effect that is used to model the variation of user positions with σ_{Ø}²=8 dB, αₕ∈[0,1] is the channel correlation coefficient, and zₜ^{c,k}˜ [symbol] (0, (1−αₕ²) β^{c,k}I) is independent of hₜ^{c,k}. We set αₕ=0.998 as default, which corresponds to user speed 1 km/h. We consider each TRP c communicates the accurate local CSI Hₜ^{c} to the CC, since the impact of channel compression error can be emulated by increasing the communication delay τᵣ.

For our performance study, we assume the CC adopts cooperative zero forcing (ZF) precoding, given by

Wₜ^{ZF}=\sqrt{Pₜ^{ZF}}Hₜ^{H}(HₜHₜ^{H})⁻¹

where Pₜ^{ZF} is a power normalizing factor. Note that we must have N≥K to perform ZF precoding. We assume all K users have the same noise σₙ²=N_{F}+N₀B_{W} and therefore all the users will have the same data rate

$${log}_{2} ( 1 + \frac{{P}_{t}^{ZF}}{{σ}_{n}^{2}} ) .$$

The CC adopts the power normalizing factor

$${P}_{t}^{Z F} = min \{ \frac{{P}_{max}^{c}}{{‖ {{H}_{t}^{c H} ( {H}_{t} {H}_{t}^{H} )}^{- 1} ‖}_{F}^{2}} , ∀ c \}$$

which is the optimal solution for the following sum rate maximization problem with per-TRP maximum transmit power limits:

$$P 4 : {max}_{{P}_{t}^{ZF} \geq 0} K {log}_{2} ( 1 + \frac{{P}_{t}^{Z F}}{{σ}_{n}^{2}} )$$

$$s . t . {P}_{t}^{Z F} {‖ {{H}_{t}^{c H} ( {H}_{t} {H}_{t}^{H} )}^{- 1} ‖}_{F}^{2} \leq {P}_{max}^{c} , ∀ c .$$

As performance metrics, we define the time-averaged normalized precoding deviation as

$$\overline{f} ( T ) {=}^{△} \frac{1}{T} {\sum }_{t = 1}^{T} \frac{{f}_{t} ( {V}_{t} )}{{‖ {H}_{t} {W}_{t}^{Z F} ‖}_{F}^{2}}$$

and the time-averaged per-user rate as

$$\overline{R} ( T ) {=}^{△} \frac{1}{T K} {\sum }_{t = 1}^{T} {\sum }_{k = 1}^{K} {log}_{2} ( 1 + S I N {R}_{t}^{k} )$$

where

$$S I N {R}_{t}^{k} = \frac{{\vert {[ {H}_{t} {V}_{t} ]}_{k , k} \vert}^{2}}{{Σ}_{j \neq k} {\vert {[ {H}_{t} {V}_{t} ]}_{k , j} \vert}^{2} + {σ}_{n}^{2}}$$

is the signal-to-interference-plus-noise ratio (SINR) of user k.

### Impact of Number of Estimated Gradient Descent Steps

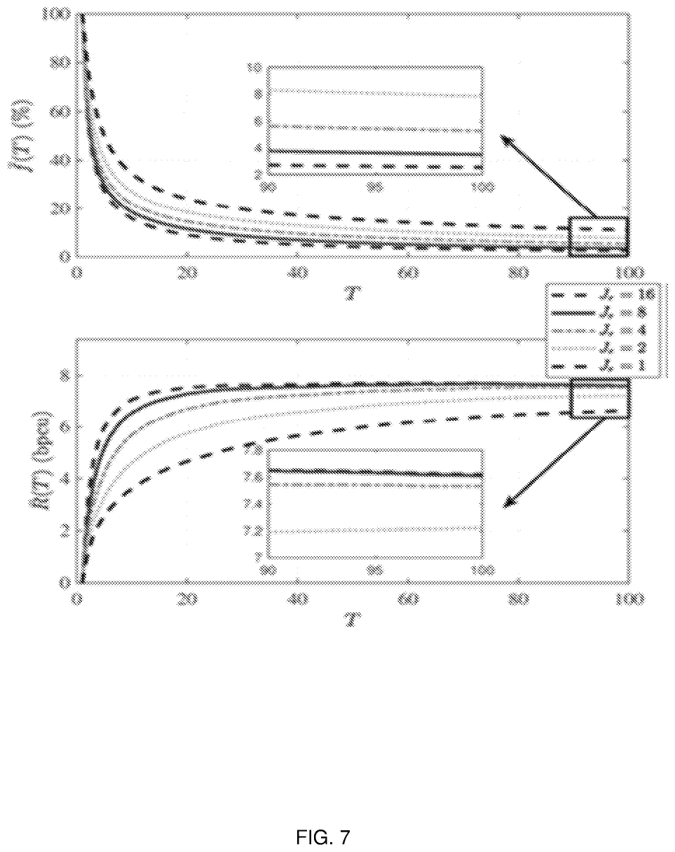

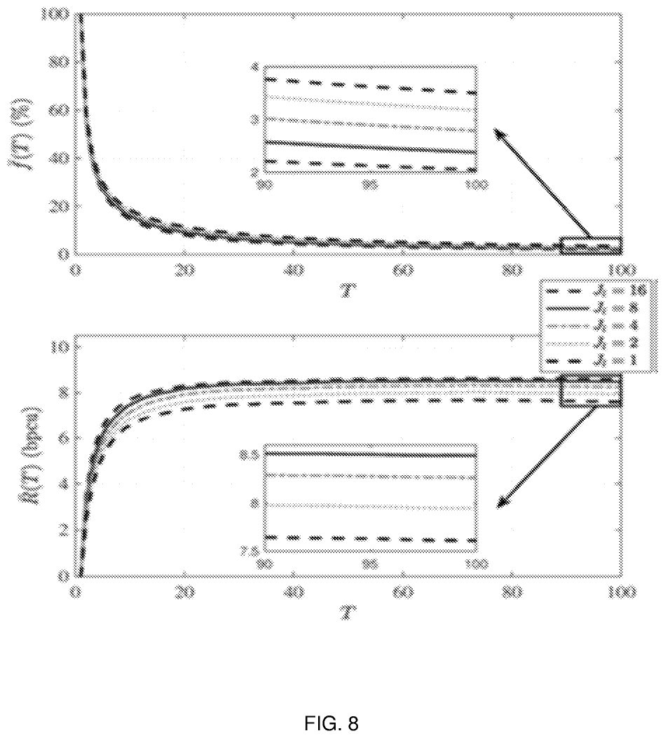

FIG. 7 shows ƒ̅(T) and R̅(T) versus T for different numbers of the estimated gradient descent steps Jᵣ at the CC and J₁ at the TRPs. We consider zero local delay first and set the remote delay as Jᵣ=1. We observe that HiOCO has fast convergence (within T=100 time slots). Furthermore, the system performance improves as Jᵣ or J₁ increases, showing the performance gain brought by performing multi-step estimated gradient descent at either the master node or worker nodes. As shown in FIG. 8, the system performance almost stabilizes when Jᵣ=8. Further considering the TRPs usually have less computation capacity compared to the CC, in the following simulation, we set J₁=1 and Jᵣ=8 as default simulation parameters.

### Impact of Channel Correlation

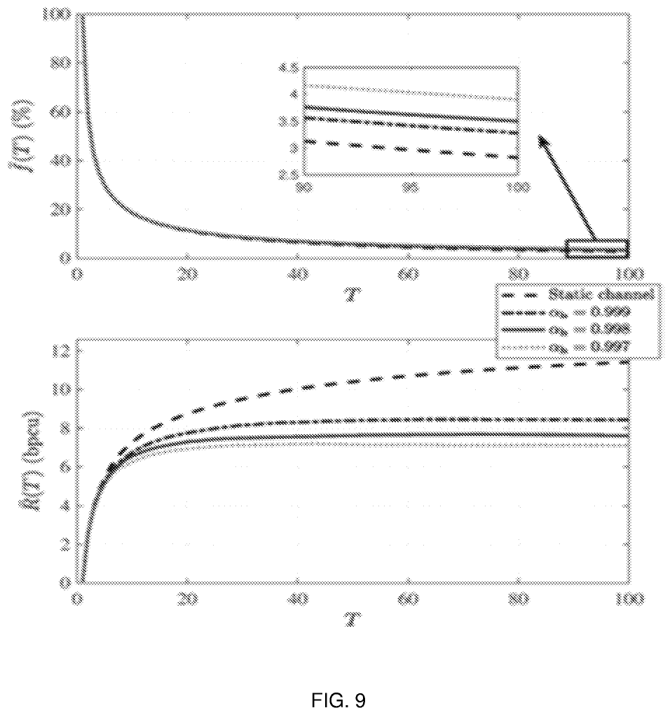

Next, we study the impact of channel correlation on the performance of HiOCO. Note that as αₕ increases, the accumulated system variation measures become smaller, leading to better dynamic regret bounds. As shown in FIG. 9, the system performance improves as αₕ increases, which is consistent with Theorems 3 and 4. When the channel is static, the steady-state per-user rate is high at 11.4 bpcu. The reason is our system is operated at high signal-to-noise ratio (SNR) region, in which the desired cooperative ZF precoding at the CC approaches the optimal precoder [43]. The steady state per-user rate decreases to 8.4 bpcu as αh increases to 0.999 which corresponds to 0.5 km/h user speed. This is because the cooperative ZF precoding nulls the inter-user interference, but its performance is sensitive to CSI inaccuracy [44] and therefore, the channel correlation in the online setting.

### Performance Comparison

For performance comparison, we consider the delayed optimal precoder V*_{t-τ}_{₁}_{-τ}_{ᵣ}=W_{t-τ}_{₁}_{-τ}_{ᵣ} that can be computed by the CC after receiving the local CSI from the TRPs at each time slot t>τ₁+τᵣ. To show the performance gain brought by the local gradient descent in HiOCO, we consider centralized OCO algorithms that perform multi-step estimated gradient descent. For distributed alternatives, we consider the idealized user association scheme that each user k selects the TRP that has the highest channel gain for downlink signal transmission at each time slot t with τ₁-slot delayed local CSI H_{t-τ}_{₁}^{c} as K_{t-τ}_{₁}^{c}. Let the number of users associated with TRP c based on H_{t-τ}_{₁}^{c} as K_{t-τ}_{₁}^{c}. Let

$${\tilde{V}}_{t - {τ}_{1}}^{c} \sqrt{{\tilde{P}}_{t - {τ}_{1}}^{c}} {{\tilde{H}}_{t - {τ}_{1}}^{cH} ( {\tilde{H}}_{t - {τ}_{1}}^{c} {\tilde{H}}_{t - {τ}_{1}}^{cH} )}^{- 1}$$

denote the available channel state between the K_{t-τ}_{₁}^{c} users and the N^{c} antennas in TRP c at each time slot t>τ₁. Each TRP c then adopts ZF precoding to serve the K_{t-τ}_{₁}^{c} users with the τ₁-delayed local CSI as

$${\tilde{V}}_{t - {τ}_{1}}^{c} = \sqrt{{\tilde{P}}_{t - {τ}_{1}}^{c}} {{\tilde{H}}_{t - {τ}_{1}}^{cH} ( {\tilde{H}}_{t - {τ}_{1}}^{c} {\tilde{H}}_{t - {τ}_{1}}^{cH} )}^{- 1}$$

where \tilde{P}_{t-τ}_{₁}^{c} is set such that ∥\tilde{V}_{t-τ}_{₁}^{c}∥_{F}²=Pₘₐₓ^{c}. We also consider a fixed user association scheme that each user k selects the TRP that has the lowest path cost and shadowing and the local CSI is delayed by τ₁ time slots at the TRPs. Let K^{c} denote the number of users associated with TRP c and H̅_{t-τ}_{₁}^{c}∈ [symbol] ^{K}^{^{c}}^{×N}^{^{c}} be available channel state between the K^{c} users and the N^{c} antennas in TRP c at each time slot t>τ₁. For the fixed user association scheme, each TRP adopts the following ZF precoding to serve the K^{c} users at each time slot t>τ₁

V̅_{t-τ}_{₁}^{c}=\sqrt{P̅_{t-τ}_{₁}^{c}}H̅_{t-τ}_{₁}^{cH}(H̅_{t-τ}_{₁}^{c}H̅_{t-τ}_{₁}^{cH})⁻¹

where P̅_{t-τ}_{₁}^{c} is set such that

$${‖ {\overline{V}}_{t - {τ}_{l}}^{c} ‖}_{F}^{2} = {P}_{max}^{c} .$$

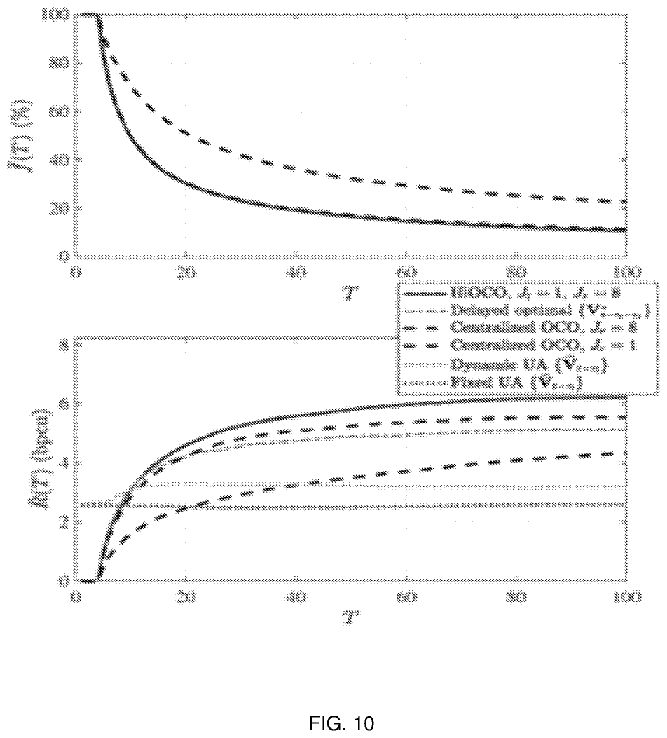

FIG. 10 shows the performance comparison between HiOCO, the delayed optimal sequence

$${\{ {V}_{t - {τ}_{l} - {τ}_{r}}^{★} \}}_{t = 1}^{T} ,$$

centralized OCO with Jᵣ=8 and Jᵣ=1 steps of gradient descent, and the dynamic and fixed user association schemes as

$${\{ {\overline{V}}_{t - {τ}_{l}} \}}_{t = 1}^{T} and {\{ {\tilde{V}}_{t - {τ}_{l}} \}}_{t = 1}^{T} ,$$

respectively, with τ₁=0 and τᵣ=4. We observe HiOCO achieves the best system performance compared with all of the above alternative schemes. Furthermore, by performing only Jᵣ=1 step additional local gradient descent at the TRPs, HiOCO achieves substantial performance gain compared with the centralized OCO with Jᵣ=8 steps of gradient descent. The user association schemes that based on the timely local CSI have worse performance compared with the other alternatives, since the TRPs are not coordinated to jointly serve the users.

### Impact of Remote and Local Delay

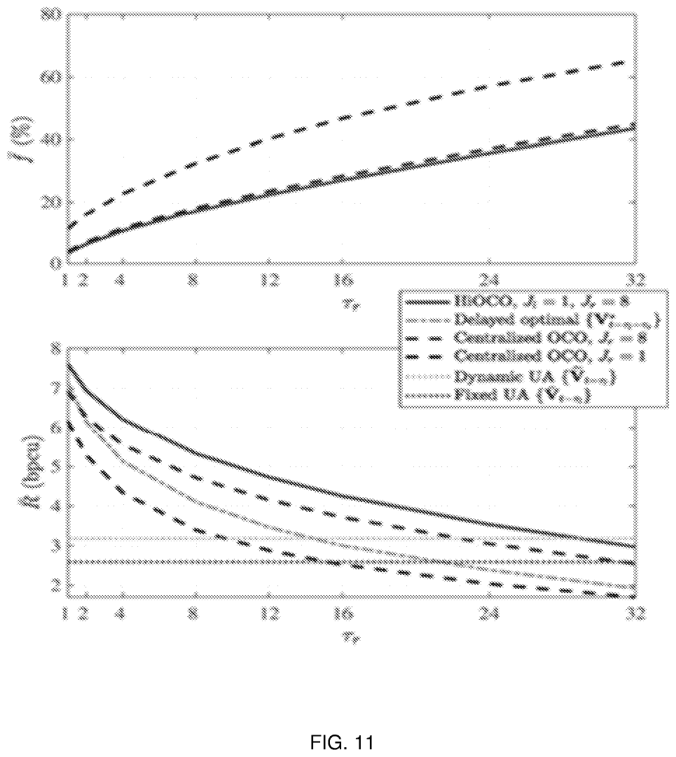

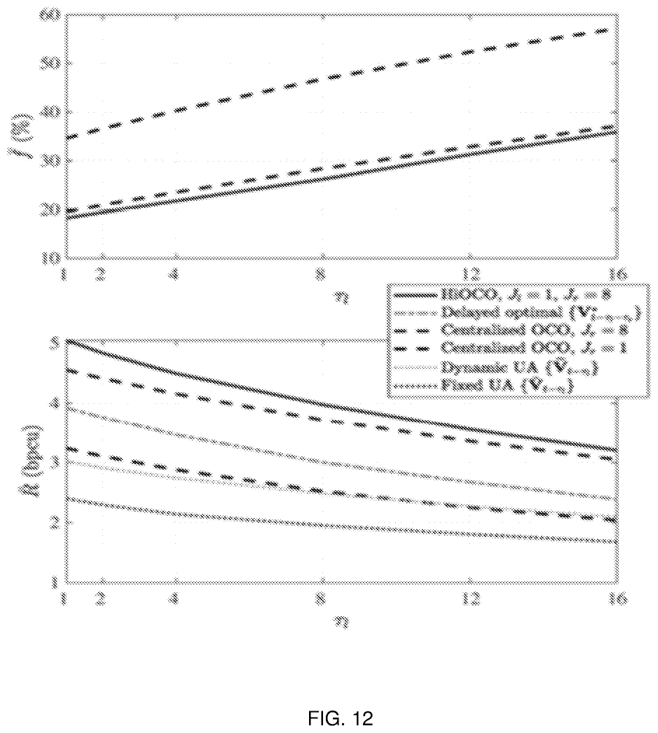

FIGS. 11 and 12 show the performance comparison on the steady state value of ƒ̅(T) and R̅(T) versus the remote delay τᵣ and local delay τₗ. As shown in FIG. 11, in a wide range of remote delay, HiOCO is better than the user association schemes that is based on the timely local CSI. It shows performance gain brought by the central gradient descent at the CC. Furthermore, HiOCO performs better than the other centralized alternatives through one-step additional local gradient descent at the TRPs. As shown in in FIG. 12, the performance gain of HiOCO over the centralized OCO algorithms decreases as the local delay τₗ increases. It indicates the importance of information timeliness on the performance gain of local gradient descent. However, in a wide range of local delay, HiOCO is better than the centralized OCO algorithms and the delayed user association schemes. By taking full advantage of the timely local CSI and delayed global CSI to perform gradient descent at both the TRPs and CC, HiOCO outperforms both the centralizes and distributed alternatives in a wide range of delay.

### Impact of Number of Antennas and Users

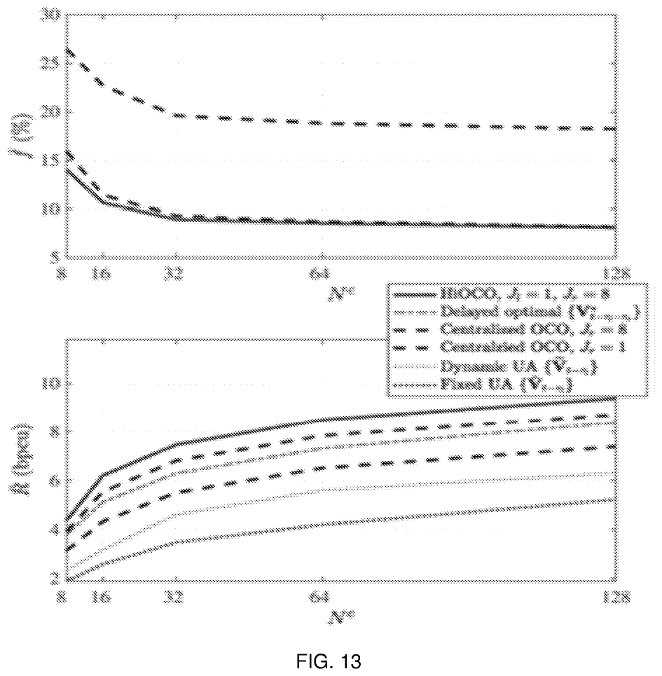

We further study the impact of number of antennas N^{c} and users K. FIG. 13 shows that the precoding deviation ƒ̅ decreases as the number of antennas N^{c} increases, since the TRPs has more degrees of freedom to design the cooperative precoding. The per-user rate R̅ drastically improves as N^{c} increases, indicating the performance advantage of massive MIMO systems.

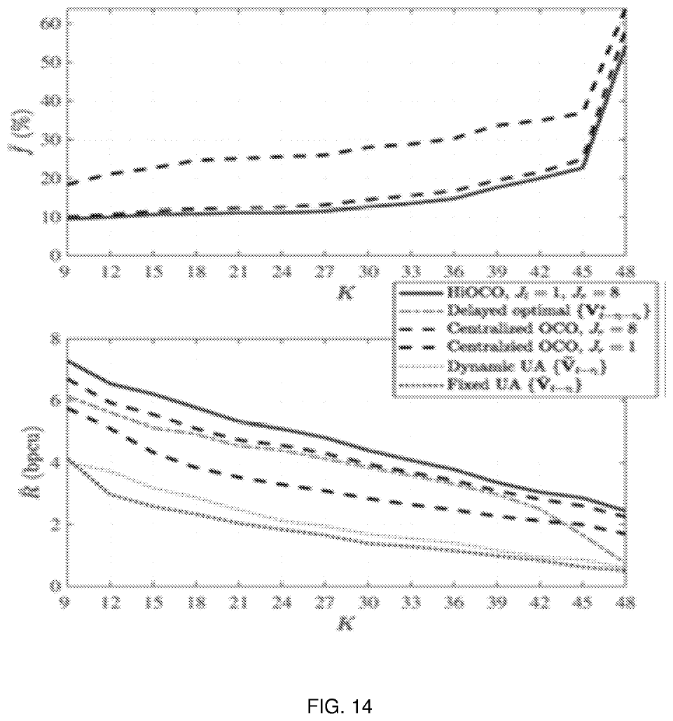

FIG. 14 shows that the precoding deviation keeps increasing as the number of users K increases, since the TRPs has less degrees of freedom to optimize the cooperative precoding for precoding deviation minimization. Note that to perform cooperative precoding at the CC, the maximum number of users is K=N=48. We observe that HiOCO substantially outperforms the delayed optimal precoder when the number of users is close to the number of antennas in the presence of delay. In a wide range of N^{c} and K, HiOCO yields the best performance among both the centralized and distributed alternatives.

### Advantages of Embodiments

Embodiments provide OCO over a heterogeneous master—worker network with communication delay, to make a sequence of online local decisions to minimize some accumulated global convex cost functions. The local data at the worker nodes may be non-i.i.d. and the global cost functions may be non-separable.

We propose a new HiOCO framework, which takes full advantage of the network heterogeneity in information timeliness and computation capacity, to enable multi-step estimated gradient descent at both the master and worker nodes. Our analysis considers the impacts of multi-slot delay, gradient estimation error, and the hierarchical architecture on the performance guarantees of HiOCO, to show sublinear dynamic regret bounds under mild conditions.

We apply HiOCO to a multi-TRP cooperative network with non-ideal backhaul links for 5G NR. We take full advantage of the information timeliness on CSI and computation resources at both the TRPs and CC to improve system performance By sharing the compressed local CSI and delayed global information, both the uplink and downlink communication overhead can be greatly reduced. The cooperative precoding solutions at both the TRPs and CC are in closed forms with low computational complexity.

Notes on the performance of the proposed methods: We numerically validate the performance of the proposed hierarchical precoding solution for multi-TRP cooperative networks under typical LTE cellular network settings. Extensive simulation results are provided to demonstrate the impact of the number of estimated gradient descent steps, channel correlation, remote and local delay, and the number of antennas and users. Simulation results demonstrate the superior delay tolerance and substantial performance advantage of HiOCO over both the centralized and distributed alternatives under different scenarios.

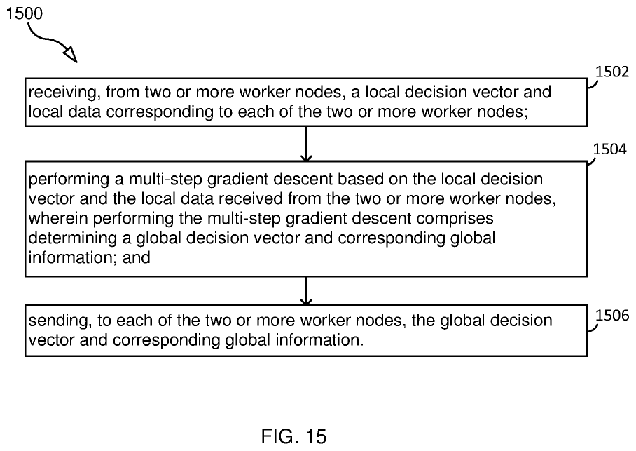

FIG. 15 is a flow chart according to an embodiment.

Process 1500 is a method for performing online convex optimization, performed e.g. by a master node such as mater node 102 and/or CC 502.

Step 1502 comprises receiving, from two or more worker nodes, a local decision vector and local data corresponding to each of the two or more worker nodes.

Step 1504 comprises performing a multi-step gradient descent based on the local decision vector and the local data received from the two or more worker nodes, wherein performing the multi-step gradient descent comprises determining a global decision vector and corresponding global information.

Step 1506 comprises sending, to each of the two or more worker nodes, the global decision vector and corresponding global information.

In some embodiments, the local data received from each of the two or more worker nodes is compressed, and wherein the method further comprises uncompressing the local data received from each of the two or more worker nodes. In some embodiments, performing the multi-step gradient descent further comprises: initializing an intermediate decision vector \hat{x}ₜ^{c,0}=x_{t-τ}_{ᵣ}^{c} for each of the two or more worker nodes c; and for each step j in the multi-step gradient descent: (1) constructing an estimated gradient for each of the two or more worker nodes c, wherein the estimated gradient is based on {\hat{x}ₜ^{c,j-1}}_{c=1}^{C} and

$${\{ {\hat{d}}_{t - {τ}_{r}}^{c} \}}_{c = 1}^{C} ,$$

and (2) updating \hat{x}ₜ^{c,j} for each of the two or more worker nodes c, by solving an optimization problem for \hat{x}ₜ^{c,j} based on the estimated gradients; where:
C refers to the number of the two or more worker nodes,
c is an index referring to a specific one of the two or more worker nodes,
t refers to the current time slot,
τᵣ refers to a round-trip remote delay,

$${\{ {x}_{t - {τ}_{r}}^{c} \}}_{c = 1}^{C}$$

refers to the local decision vectors received from each of the two or more worker nodes,

$${\{ {\hat{d}}_{t - {τ}_{r}}^{c} \}}_{c = 1}^{C}$$

refers to compressed local data for each of the two or more worker nodes that is based on the local data received from each of the two or more worker nodes,
j∈[1, Jᵣ], and
Jᵣ refers to the number of steps of the multi-step gradient descent.

In some embodiments, the estimated gradient is given by

$$∇ {\hat{f}}_{t - {τ}_{r}}^{C} ( {\hat{x}}_{t}^{c , j - 1} ) {=}^{△} {h}_{f}^{c} ( {\hat{d}}_{t - {τ}_{r}}^{c} , {\hat{x}}_{t}^{c , j - 1} , {g}_{f}^{c} ( {\{ {\hat{d}}_{t - {τ}_{r}}^{l} \}}_{l \neq c} , {\{ {\hat{x}}_{t}^{l , j - 1} \}}_{l \neq c} ) ) ,$$

the optimization problem is given by

$${min}_{{x}^{c} ∈ {𝒳}^{c}} 〈 ∇ {\hat{f}}_{t - {τ}_{r}}^{c} ( {\hat{x}}_{t}^{c , j - 1} ) , {x}^{c} - {\hat{x}}_{t}^{c , j - 1} 〉 + \frac{α}{2} {‖ {x}^{c} - {\hat{x}}_{t}^{c , j - 1} ‖}_{2}^{2} ,$$

and the corresponding global information for a given worker node c is given by

$${g}_{f}^{c} ( {\{ {\hat{d}}_{t - {τ}_{r}}^{l} \}}_{l \neq c} , {\{ {\hat{x}}_{t}^{l , {J}_{r}} \}}_{l \neq c} ) ;$$

where:
∇\hat{ƒ}_{t-τ}_{ᵣ}^{c}( ) refers to a local gradient function,
h_{f}^{c}( ) refers to a general function,
[symbol] ^{c} refers to a compact convex feasible set, and
α refers to a fixed parameter.

In some embodiments, the local data corresponding to each of the two or more worker nodes has a non-zero local delay. In some embodiments, the two or more worker nodes comprise transmission/reception points (TRPs), the local data corresponds to local channel state information, and the local decision vectors correspond to precoding matrices. In some embodiments, performing the multi-step gradient descent further comprises: initializing an intermediate precoding matrix \hat{V}ₜ^{c,0}=V_{t-τ}_{ᵣ}^{c} for each of the two or more TRPs c; and for each step j in the multi-step gradient descent: (1) constructing an estimated gradient for each of the two or more TRPs c, wherein the estimated gradient is based on

$${\{ {V}_{t - {τ}_{r}}^{c} \}}_{c = 1}^{C} and {\{ {\hat{H}}_{t - {τ}_{r}}^{c} \}}_{c = 1}^{C} ,$$

and (2) updating \hat{V}ₜ^{c,j} for each of the two or more TRPs c, by solving an optimization problem for \hat{V}ₜ^{c,j} based on the estimated gradients; where:
C refers to the number of the two or more worker nodes,
c is an index referring to a specific one of the two or more worker nodes
t refers to the current time slot,
τᵣ refers to a round-trip remote delay,

$${\{ {V}_{t - {τ}_{r}}^{c} \}}_{c = 1}^{C}$$

refers to the local precoding matrices received from each of the two or more TRPs,

$${\{ {\hat{H}}_{t - {τ}_{r}}^{c} \}}_{c = 1}^{C}$$

refers to compressed local channel state information for each of the two or more TRPs that is based on the local channel state information received from each of the two or more TRPs,
j∈[1, Jᵣ], and
Jᵣ refers to the number of steps of the multi-step gradient descent.

In some embodiments, the estimated gradient is given by ∇ƒ_{t-τ}_{ᵣ}^{c}(\hat{V}ₜ^{c,j-1})=Ĥ_{t-τ}_{ᵣ}^{c}(Ĥ_{t-τ}_{ᵣ}^{l}\hat{V}ₜ^{l,j-1})−Ĥ_{t-τ}_{ᵣ}Ŵ_{t-τ}_{ᵣ}), a solution to the optimization problem is given by

$${\hat{V}}_{t}^{c , j} = {𝒫}_{{𝒱}^{c}} \{ {\hat{V}}_{t}^{c , j - 1} - \frac{1}{α} ∇ {\hat{f}}_{t - {τ}_{r}}^{c} ( {\hat{V}}_{t}^{c , j - 1} ) \} ,$$

and the corresponding global information for a given TRP c is given by Ĝ_{t-τ}^{c}=Σ_{l=1,l≠c}(Ĥ_{t-τ}^{l}\hat{V}ₜ^{l,J}^{ᵣ})−Ĥ_{t-τ}_{ᵣ}Ŵ_{l-τ}_{ᵣ}∈ [symbol] ^{K×K}; where

$${𝒫}_{{𝒱}^{c}} \{ {V}^{c} \} = arg {min}_{{U}^{c} ∈ {𝒱}^{c}} \{ {‖ {U}^{c} - {V}^{c} ‖}_{F}^{2} \}$$

is the projection operator onto the convex feasible set V^{c},
Ŵ_{t-τ}_{ᵣ} refers to a desired global precoding matrix,
∇\hat{ƒ}_{t-τ}_{ᵣ}^{c}( ) refers to a local gradient function, and
α refers to a fixed parameter.

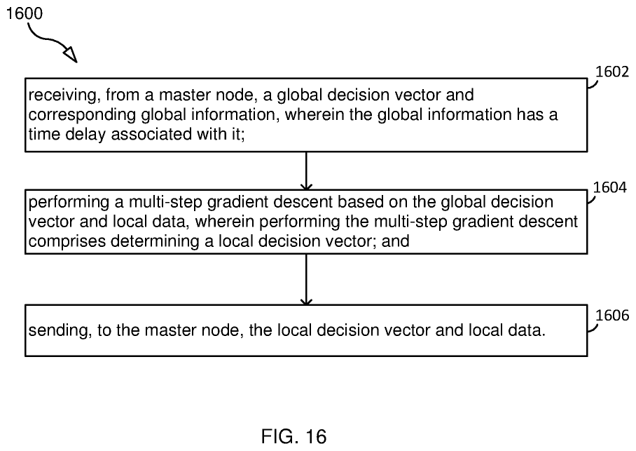

FIG. 16 is a flow chart according to an embodiment.

Process 1600 is a method for performing online convex optimization, performed e.g. by a worker node such as worker node 104 and/or TRP 504.

Step 1602 comprises receiving, from a master node, a global decision vector and corresponding global information, wherein the global information has a time delay associated with it.

Step 1604 comprises performing a multi-step gradient descent based on the global decision vector and local data, wherein performing the multi-step gradient descent comprises determining a local decision vector.

Step 1606 comprises sending, to the master node, the local decision vector and local data.

In some embodiments, the local data sent to the master node is compressed prior to sending. In some embodiments, performing the multi-step gradient descent further comprises:
initializing an intermediate decision vector \tilde{x}ₜ^{c,0}=\hat{x}ₜ^{c,J}^{ᵣ}; and for each step j in the multi-step gradient descent: (1) constructing an estimated gradient, wherein the estimated gradient is based on dₜ^{c} and

$${g}_{f}^{c} ( {\{ {\hat{d}}_{t - {τ}_{r}}^{l} \}}_{l \neq c} , {\{ {\hat{x}}_{t}^{l , {J}_{r}} \}}_{l \neq c} ) ,$$

and (2) updating \tilde{x}ₜ^{c,j}, by solving an optimization problem for \tilde{x}ₜ^{c,j} based on the estimated gradient; where:
c is an index referring to a worker node corresponding to the local data,
t refers to the current time slot,
τᵣ refers to a round-trip remote delay,
dₜ^{c} refers to the local data,
\hat{x}ₜ^{c,J}^{ᵣ} refers to the global decision vector,

$${g}_{f}^{c} ( {\{ {\hat{d}}_{t - {τ}_{r}}^{l} \}}_{l \neq c} , {\{ {\hat{x}}_{t}^{l , {J}_{r}} \}}_{l \neq c} )$$

refers to the global information,
j∈[1,J₁], and
J₁ refers to the number of steps of the multi-step gradient descent.

In some embodiments, the estimated gradient is given by

$$∇ {\hat{f}}_{t}^{c} ( {\tilde{x}}_{t}^{c , j - 1} ) {=}^{△} {h}_{f}^{c} ( {d}_{t}^{c} , {\tilde{x}}_{t}^{c , j - 1} , {g}_{f}^{c} ( {\{ {\hat{d}}_{t - {τ}_{r}}^{l} \}}_{l \neq c} , {\{ {\hat{x}}_{t}^{l , Jr} \}}_{l \neq c} ) ) ,$$

the optimization problem is given by

$${min}_{{x}^{c} ∈ {𝒳}^{c}} 〈 ∇ {\hat{f}}_{t}^{c} ( {\tilde{x}}_{t}^{c , j - 1} ) , {x}^{c} - {\tilde{x}}_{t}^{c , j - 1} 〉 + \frac{α}{2} {‖ {x}^{c} - {\tilde{x}}_{t}^{c , j - 1} ‖}_{2}^{2} ,$$

and the local decision vector given by xₜ^{c}=
\tilde{x}ₜ^{c,J}^{₁}; where:
∇\hat{ƒ}ₜ^{c}( ) refers to a local gradient function,
h_{f}^{c}( ) refers to a general function,
X^{c} refers to a compact convex feasible set, and
α refers to a fixed parameter.

In some embodiments, the local data has a non-zero local delay. In some embodiments, the local data corresponds to local channel state information, and the local decision vectors correspond to precoding matrices. In some embodiments, performing the multi-step gradient descent further comprises: initializing an intermediate precoding matrix if \tilde{V}ₜ^{c,0}=\tilde{V}ₜ^{c,J}^{ᵣ}; and for each step j in the multi-step gradient descent: (1) constructing an estimated gradient, wherein the estimated gradient is based on H_{t-τ}_{₁}^{c} and Ĝ_{t-τ}^{c}, and (2) updating \tilde{V}ₜ^{c,j}, by solving an optimization problem for if \tilde{V}ₜ^{c,j} based on the estimated gradient; where:

c is an index referring to a worker node corresponding to the local data,
t refers to the current time slot,
τᵣ refers to a round-trip remote delay,
τ₁ refers to a local delay,
τ refers to the total delay,
Hₜ^{c} refers to the local channel state information,
\tilde{V}ₜ^{c,J}^{ᵣ} refers to the global precoding matrix,
Ĝ_{t-τ}^{c} refers to the global information,
j∈[1,J₁], and
J₁ refers to the number of steps of the multi-step gradient descent.

In some embodiments, the estimated gradient is given by ∇\hat{ƒ}_{t-τ}_{₁}^{c}(\tilde{V}ₜ^{c,j-1})=H_{t-τ}_{₁}^{c}(H_{t-τ}_{₁}^{c} \tilde{V}ₜ^{c,j-1}+Ĝ_{t-τ}^{c}), a solution the optimization problem is given by

$${\tilde{V}}_{t}^{c , j} = {𝒫}_{{𝒱}^{c}} \{ {\tilde{V}}_{t}^{c , j - 1} - \frac{1}{α} ∇ {\hat{f}}_{t - {τ}_{1}}^{c} ( {\tilde{V}}_{t}^{c , j - 1} ) \} ,$$

and the local precoding matrix given by Vₜ^{c}=\tilde{V}ₜ^{c,J}^{₁}; where:

$${𝒫}_{{𝒱}^{c}} \{ {V}^{c} \} = arg {min}_{{U}^{c} ∈ {𝒱}^{c}} \{ {‖ {U}^{c} - {V}^{c} ‖}_{F}^{2} \}$$

is the projection operator onto the convex feasible set V^{c}, ∇\hat{ƒ}_{t-τ}_{₁}^{c}( ) refers to a local gradient function, and
α refers to a fixed parameter.

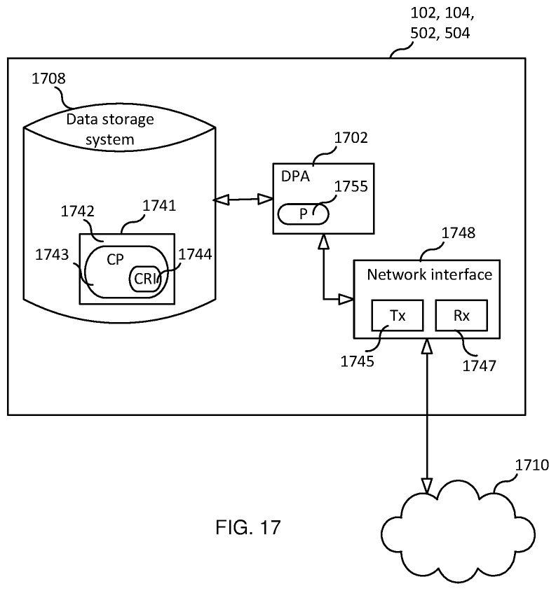

FIG. 17 is a block diagram of an apparatus such as master node 102, worker node 104, CC 502, and/or TRP 504, according to some embodiments. As shown in FIG. 17, the apparatus may comprise: processing circuitry (PC) 1702, which may include one or more processors (P) 1755 (e.g., a general purpose microprocessor and/or one or more other processors, such as an application specific integrated circuit (ASIC), field-programmable gate arrays (FPGAs), and the like); a network interface 1748 comprising a transmitter (Tx) 1745 and a receiver (Rx) 1747 for enabling the apparatus to transmit data to and receive data from other nodes connected to a network 1710 (e.g., an Internet Protocol (IP) network) to which network interface 1748 is connected; and a local storage unit (a.k.a., “data storage system”) 1708, which may include one or more non-volatile storage devices and/or one or more volatile storage devices. In embodiments where PC 1702 includes a programmable processor, a computer program product (CPP) 1741 may be provided. CPP 1741 includes a computer readable medium (CRM) 1742 storing a computer program (CP) 1743 comprising computer readable instructions (CRI) 1744. CRM 1742 may be a non-transitory computer readable medium, such as, magnetic media (e.g., a hard disk), optical media, memory devices (e.g., random access memory, flash memory), and the like. In some embodiments, the CRI 1744 of computer program 1743 is configured such that when executed by PC 1702, the CRI causes the apparatus to perform steps described herein (e.g., steps described herein with reference to the flow charts). In other embodiments, the apparatus may be configured to perform steps described herein without the need for code. That is, for example, PC 1702 may consist merely of one or more ASICs. Hence, the features of the embodiments described herein may be implemented in hardware and/or software.

While various embodiments of the present disclosure are described herein, it should be understood that they have been presented by way of example only, and not limitation. Thus, the breadth and scope of the present disclosure should not be limited by any of the above-described example embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] S. Shalev-Shwartz, “Online learning and online convex optimization,” Found. Trends Mach. Learn., vol. 4, pp. 107-194, February 2012.
[2] E. Hazan, “Introduction on online convex optimization,” Found. Trends Optim., vol. 2, pp. 157-325, August 2016.
[3] M. Zinkevich, “Online convex optimization and generalized infinitesimal gradient descent,” in Proc. Intel. Conf. Mach. Learn. (ICML), 2003.
[4] E. Hazan, A. Agarwal and S. Kale, “Logarithmic regret algorithms for online convex optimization,” Mach. Learn., vol. 69, pp. 169-192, 2007.
[5] J. Langford, A. J. Smola and M. Zinkevich, “Slow learners are fast,” in Proc. Adv. Neural Info. Proc. Sys. (NIPS), 2009.
[6] K. Quanrud and D. Khashabi, “Online learning with adversarial delays,” in Proc. Adv. Neural Info. Proc. Sys. (NIPS), 2015.
[7] E. C. Hall and R. M. Willett, “Online convex optimization in dynamic environments,” IEEE J. Sel. Topics Signal Process., vol. 9, pp. 647-662, June 2015.
[8] A. Jadbabaie, A. Rakhlin, S. Shahrampour and K. Sridharan, “Online optimization: competing with dynamic comparators,” in Proc. Intel. Conf. Artif. Intell. Statist. (AISTATS), 2015.
[9] A. Mokhtari, S. Shahrampour, A. Jababaie and A. Ribeiro, “Online optimization in dynamic environments: Improved regret rates for strongly convex problems,” in Proc. IEEE Conf. Decision Control (CDC), 2016.
[10] L. Zhang, T. Yang, J. Yi, J. Rong and Z.-H. Zhou, “Improved dynamic regret for non-degenerate functions,” in Proc. Adv. Neural Info. Proc. Sys. (NIPS), 2017.
[11] A. S. Bedi, P. Sarma and K. Rajawat, “Tracking moving agents via inexact online gradient descent algorithm,” IEEE J. Sel. Topics Signal Process, vol. 12, pp. 202-217, 2018.
[12] R. Dixit, A. S. Bedi, R. Tripathi and K. Rajawat, “Online learning with inexact proximal online gradient descent algorithms,” IEEE Trans. Signal Process., vol. 67, pp. 1338-1352, 2019.
[13] 3. TS38.300, “3rd Generation Partnership Project Technical Specification Group Radio Access Network; NR; NR and NG-RAN Overall Description; Stage 2 (Release 15)”.
[14] B. Liang, “Mobile edge computing,” in Key Technologies for 5G Wireless Systems, Cambridge University Press, 2017.
[15] J. P. Champati and B. Liang, “Semi-online algorithms for computational task offloading with communication delay,” IEEE Trans. Parallel Distrib. Syst., vol. 28, pp. 1189-1201, 2017.
[16] S. J. Wright, “Coordinated descent algorithms,” Math. Programming, vol. 151, pp. 3-34, 2015.
[17] S. Boyd, N. Parikh, E. Chu, B. Peleato and J. Eckstein, “Distributed optimization and statistical learning via the alternating direction method of multipliers,” Found. Trends Mach. Learn., vol. 3, pp. 1-122, 2011.
[18] M. Hong, T.-H. Chang, X. Wang, M. Razaviyayn, S. Ma and Z.-Q. Luo, “A block successive upper-bound minimization method of multipliers for linearly constrained convex optimization,” Math. Oper. Res., vol. 45, pp. 933-961, 2020.
[19] M. Zinkevich, M. Weimer, L. Li and A. J. Smola, “Parallelized stochastic gradient descent,” in Proc. Adv. Neural Info. Proc. Sys. (NIPS), 2010.
[20] H. B. McMahan, S. H. Moore, D. Ramage and B. A. y. Arcas, “Communication-efficient learning of deep networks for decentralized data,” in Proc. Intel. Conf. Artif. Intell. Statist. (AISTATS), 2017.
[21] J. C. Duchi, A. Agarwal and M. J. Wainwright, “Dual averaging for distributed optimization: convergence analysis and network scaling,” IEEE Trans. Autom. Control, vol. 57, pp. 592-606, 2012.
[22] D. Mateos-Nez and J. Corts, “Distributed online convex optimization over jointly connected digraphs,” IEEE Trans. Netw. Sci. Eng., vol. 1, pp. 23-37, 2014.
[23] A. Koppel, F. Y. Jakubiec and A. Riveiro, “A saddle point algorithm for networked online convex optimization,” IEEE Trans. Signal Process., vol. 63, pp. 5149-5164, 2015.
[24] M. Akbari, B. Gharesifard and T. Linder, “Distributed online convex optimization on time-varying directed graphs,” IEEE Trans. Control Netw. Syst., vol. 4, pp. 417-428, 2017.
[25] S. Shahrampour and A. Jadbabaie, “Distributed online optimization in dynamic environments using mirror descent,” IEEE Trans. Autom. Control, vol. 63, pp. 714-725, March 2018.
[26] N. Eshraghi and B. Liang, “Distributed online optimization over a heterogeneous network with any-batch mirror descent,” in Proc. Intel. Conf. Mach. Learn. (ICML), 2020.
[27] Y. Zhang, R. J. Ravier, M. M. Zavlanos and V. Tarokh, “A distributed online convex optimization algorithm with improved dynamic regret,” in Proc. IEEE Conf. Decision Control (CDC), 2019.
[28] M. J. Neely, Stochastic Network Optimization with Application on Communication and Queueing Systems, Morgan & Claypool, 2010.
[29] F. Amirnavaei and M. Dong, “Online power control optimization for wireless transmission with energy harvesting and storage,” IEEE Trans. Wireless Commun., vol. 66, pp. 4888-4901, July 2016.
[30] M. Dong, W. Li and F Amirnavaei, “Online joint power control for two-hop wireless relay networks with energy harvesting,” IEEE Trans. Signal Process., vol. 66, pp. 462-478, January 2018.
[31] J. Wang, M. Dong, B. Liang and G. Boudreau, “Online downlink MIMO wireless network virtualization in fading environments,” in Proc. IEEE Global Commun. Conf. (GLOBECOM), 2019.
[32] J. Wang, M. Dong, B. Liang and G. Boudreau, “Online precoding design for downlink MIMO wireless network virtualization with imperfect CSI,” in Proc. IEEE Conf. Comput. Commun. (INFOCOM), 2020.
[33] P. Mertikopoulos and E. V. Belmega, “Learning to be green: Robust energy efficiency maximization in dynamic MIMO-OFDM system,” IEEE J. Sel. Areas. Commun., vol. 34, pp. 743-757, April 2016.
[34] P. Mertikopoulos and A. L. Moustakas, “Learning in an uncertain world: MIMO covariance matirx optimization with imperfect feedback,” IEEE Trans. Signal Process., vol. 64, pp. 5-18, January 2016.
[35] H. Yu and M. J. Neely, “Dynamic transmit covariance design in MIMO fading systems with unknown channel distributions and inaccurate channel state information,” IEEE Trans. Wirelss Commun., vol. 16, pp. 3996-4008, June 2017.
[36] J. Wang, B. Liang, M. Dong and G. Boudreau, “Online MIMO wireless network virtualization over time-varying channels with periodic updates,” in Proc. IEEE Intel. Workshop on Signal Process. Advances in Wireless Commun. (SPAWC), 2020.
[37] D. Gesbert, S. Hanly, H. Huang, S. S. shiz, O. Simeone and W. Yu, “Multi-cell MIMO cooperative networks: A new look at interference,” IEEE J. Sel. Topics Signal Process., vol. 28, pp. 1308-1408, December 2010.
[38] H. Zhang, N. B. Mehta, A. F. Molisch, J. Zhang and S. H. Dai, “Asynchronous interfence mitigation in cooperative base station systems,” IEEE Trans. Wireless Commun., vol. 7, pp. 155-165, January 2008.
[39] R. Zhang, “Cooperative multi-cell block diagonalization with per-base-station power constraints,” IEEE J. Sel. Areas. Commun., vol. 28, pp. 1435-1445, 2010.
[40] O. Besbes, Y. Gur and A. Zeevi, “Non-stationary stochastic optimization,” Oper. Res., vol. 63, pp. 1227-1244, September 2015.
[41] M. Abadi, A. Chu, I. Goodfellow, H. B. McMahan, I. Mironov, K. Talwar and L. Zhang, “Deep learning with differential privacy,” in Proc. ACM SIGSAC Conf. Comput. Commun. Secur. (CCS), 2016.
[42] H. Holma and A. Toskala, WCDMA for UMTS-HSPA evolution and LTE, John Wiely & Sons, 2010.
[43] Y. Jiang, M. K. Varanasi and J. Li, “Performance analysis of ZF and MMSE equalizers for MIMO systems: An in-depth study of the high SNR regime,” IEEE Trans. Inf. Theory, vol. 57, pp. 2008-2026, April 2011.
[44] R. Corvaja and A. G. Armada, “Phase noise degradation in massive MIMO downlink with zero-forcing and maximum ratio transmission precoding,” IEEE Trans. Veh. Technol., vol. 65, pp. 8052-8059, October 2016.

1. A method for performing online convex optimization, the method comprising:
receiving, from two or more worker nodes, a local decision vector and local data corresponding to each of the two or more worker nodes;
performing a multi-step gradient descent based on the local decision vector and the local data received from the two or more worker nodes, wherein performing the multi-step gradient descent comprises determining a global decision vector and corresponding global information; and
sending, to each of the two or more worker nodes, the global decision vector and corresponding global information.

2. The method of claim 1, wherein the local data received from each of the two or more worker nodes is compressed, and wherein the method further comprises uncompressing the local data received from each of the two or more worker nodes.

3. The method of claim 1, wherein performing the multi-step gradient descent further comprises:
initializing an intermediate decision vector \hat{x}ₜ^{c,0}=x_{t-τ}_{ᵣ}^{c}, for each of the two or more worker nodes c;
for each step j in the multi-step gradient descent:
(1) constructing an estimated gradient for each of the two or more worker nodes c, wherein the estimated gradient is based on {\hat{x}ₜ^{c,j-1}}_{c=1}^{C} and
$${\{ {\hat{d}}_{t - {τ}_{c}}^{c} \}}_{c = 1}^{C} ,$$
and
(2) updating \hat{x}ₜ^{c,j} for each of the two or more worker nodes c, by solving an optimization problem for \hat{x}ₜ^{c,j} based on the estimated gradients;
where:
C refers to the number of the two or more worker nodes,
c is an index referring to a specific one of the two or more worker nodes,
t refers to the current time slot,
τᵣ refers to a round-trip remote delay,
$${\{ {x}_{t - {τ}_{r}}^{c} \}}_{c = 1}^{C}$$
refers to the local decision vectors received from each of the two or more worker nodes,
$${\{ {\hat{d}}_{t - {τ}_{r}}^{c} \}}_{c = 1}^{C}$$
refers to compressed local data for each of the two or more worker nodes that is based on the local data received from each of the two or more worker nodes,
j∈[1,Jᵣ], and
Jᵣ refers to the number of steps of the multi-step gradient descent.

4. The method of claim 3,
wherein the estimated gradient is given by
$$∇ {\hat{f}}_{t - {τ}_{r}}^{c} ( {\hat{x}}_{t}^{c , j - 1} ) {=}^{△} {h}_{f}^{c} ( {\hat{d}}_{t - {τ}_{r}}^{c} , {\hat{x}}_{t}^{c , j - 1} , {g}_{f}^{c} ( {\{ {\hat{d}}_{t - {τ}_{r}}^{l} \}}_{l \neq c} , {\{ {\hat{x}}_{t}^{l , j - 1} \}}_{l \neq c} ) ) ,$$
wherein the optimization problem is given by
$${min}_{{x}^{c} ∈ {𝒳}^{c}} 〈 ∇ {\hat{f}}_{t - {τ}_{r}}^{c} ( {\hat{x}}_{t}^{c , j - 1} ) , {x}^{c} - {\hat{x}}_{t}^{cj , - 1} 〉 + \frac{α}{2} {‖ {x}^{c} - {\hat{x}}_{t}^{c , j - 1} ‖}_{2}^{2} ,$$
and
wherein the corresponding global information for a given worker node c is given by
$${g}_{f}^{c} ( {\{ {\hat{d}}_{t - {τ}_{r}}^{l} \}}_{l \neq c} , {\{ {\hat{x}}_{t}^{l , {J}_{r}} \}}_{l \neq c} ) ;$$
where:
∇\hat{ƒ}_{t-τ}_{ᵣ}^{c}( ) refers to a local gradient function,
h_{f}^{c}( ) refers to a general function,
X^{c} refers to a compact convex feasible set, and
α refers to a fixed parameter.

5. The method of claim 1, wherein the local data corresponding to each of the two or more worker nodes has a non-zero local delay.

6. The method of claim 1, wherein the two or more worker nodes comprise transmission/reception points (TRPs), the local data corresponds to local channel state information, and the local decision vectors correspond to precoding matrices.

7. The method of claim 6, wherein performing the multi-step gradient descent further comprises:
initializing an intermediate precoding matrix \hat{V}ₜ^{c,0}=V_{t-τ}_{ᵣ}^{c}, for each of the two or more TRPs c;
for each step j in the multi-step gradient descent:
(1) constructing an estimated gradient for each of the two or more TRPs c, wherein the estimated gradient is based on
$${\{ {V}_{t - {τ}_{r}}^{c} \}}_{c = 1}^{C} and {\{ {\hat{H}}_{t - {τ}_{r}}^{c} \}}_{c = 1}^{C} ,$$
and
(2) updating \hat{V}ₜ^{c,j} for each of the two or more TRPs c, by solving an optimization problem for \hat{V}ₜ^{c,j} based on the estimated gradients;
where:
C refers to the number of the two or more worker nodes,
c is an index referring to a specific one of the two or more worker nodes,
t refers to the current time slot,
τᵣ refers to a round-trip remote delay,
$${\{ {V}_{t - {τ}_{r}}^{c} \}}_{c = 1}^{C}$$
refers to the local precoding matrices received from each of the two or more TRPs,
$${\{ {\hat{H}}_{t - {τ}_{r}}^{c} \}}_{c = 1}^{C}$$
refers to compressed local channel state information for each of the two or more TRPs that is based on the local channel state information received from each of the two or more TRPs,
j∈[1,Jᵣ], and
Jᵣ refers to the number of steps of the multi-step gradient descent.

8. The method of claim 7,
wherein the estimated gradient is given by ∇\hat{ƒ}_{t-τ}_{ᵣ}^{c}(\hat{V}ₜ^{c,j-1})=Ĥ_{t-τ}_{ᵣ}^{c}(Σₜ₌₁^{C}(Ĥ_{t-τ}_{ᵣ}^{l}\hat{V}ₜ^{l,j-1})−Ĥ_{t-τ}_{ᵣ}Ŵ_{t-τ}_{ᵣ}),
wherein a solution to the optimization problem is given by
$${\hat{V}}_{t}^{c , j} = {𝒫}_{{𝒱}^{c}} \{ {\hat{V}}_{t}^{c , j - 1} - \frac{1}{α} ∇ {\hat{f}}_{t - {τ}_{r}}^{c} ( {\hat{V}}_{t}^{c , j - 1} ) \} ,$$
and
wherein the corresponding global information for a given TRP c is given by Ĝ_{t-τ}^{c}=Σ_{l=1,l≠c}^{C}(Ĥ_{t-τ}_{ᵣ}^{l} Vₜ^{l,J}^{ᵣ})−Ĥ_{t-τ}_{ᵣ} Ŵ_{t-τ}_{ᵣ}∈ [symbol] ^{K×K.}
where:
$${𝒫}_{{𝒱}^{c}} \{ {V}^{c} \} = arg {min}_{{U}^{c} ∈ {𝒱}^{c}} \{ {‖ {U}^{c} - {V}^{c} ‖}_{F}^{2} \}$$
is the projection operator onto the convex feasible set [symbol] ^{c},
Ŵ_{t-τ}_{ᵣ}, refers to a desired global precoding matrix,
∇\hat{ƒ}_{t-τ}_{ᵣ}^{c}( ) refers to a local gradient function, and
α refers to a fixed parameter.

9. A method for performing online convex optimization, the method comprising:
receiving, from a master node, a global decision vector and corresponding global information, wherein the global information has a time delay associated with it;
performing a multi-step gradient descent based on the global decision vector and local data, wherein performing the multi-step gradient descent comprises determining a local decision vector; and
sending, to the master node, the local decision vector and local data.

10. The method of claim 9, wherein the local data sent to the master node is compressed prior to sending.

11. The method of claim 9, wherein performing the multi-step gradient descent further comprises:
initializing an intermediate decision vector \tilde{x}ₜ^{c,0}=\hat{x}ₜ^{c,J}^{ᵣ};
for each step j in the multi-step gradient descent:
(1) constructing an estimated gradient, wherein the estimated gradient is based on dₜ^{c} and
$${g}_{f}^{c} ( {\{ {\hat{d}}_{t - {τ}_{r}}^{l} \}}_{l \neq c} , {\{ {\hat{x}}_{t}^{l , {J}_{r}} \}}_{l \neq c} ) ,$$
and
(2) updating \hat{x}ₜ^{c,j} by solving an optimization problem for \tilde{x}ₜ^{c,j} based on the estimated gradient;
where:
c is an index referring to a worker node corresponding to the local data,
t refers to the current time slot,
τᵣ refers to a round-trip remote delay,
dₜ^{c} refers to the local data,
\hat{x}ₜ^{c,J}^{ᵣ} refers to the global decision vector,
$${g}_{f}^{c} ( {\{ {\hat{d}}_{t - {τ}_{r}}^{l} \}}_{l \neq c} , {\{ {\hat{x}}_{t}^{l , {J}_{r}} \}}_{l \neq c} )$$
refers to the global information,
j∈[1,J₁], and
J₁ refers to the number of steps of the multi-step gradient descent.

12. The method of claim 11,
wherein the estimated gradient is given by
$$∇ {\hat{f}}_{t}^{c} ( {\tilde{x}}_{t}^{c , j - 1} ) {=}^{△} {h}_{f}^{c} ( {d}_{t}^{c} , {\tilde{x}}_{t}^{c , j - 1} , {g}_{f}^{c} ( {\{ {\hat{d}}_{t - {τ}_{r}}^{l} \}}_{l \neq c} , {\{ {\hat{x}}_{t}^{l , {J}_{r}} \}}_{l \neq c} ) ) ,$$
wherein the optimization problem is given by
$${min}_{{x}^{c} ∈ {𝒳}^{c}} 〈 ∇ {\hat{f}}_{t}^{c} ( {\tilde{x}}_{t}^{c , j - 1} ) , {x}^{c} - {\tilde{x}}_{t}^{c , j - 1} 〉 + \frac{α}{2} {‖ {x}^{c} - {\tilde{x}}_{t}^{c , j - 1} ‖}_{2}^{2} ,$$
and
wherein the local decision vector given by xₜ^{c}=\tilde{x}ₜ^{c,J}^{₁};
where:
∇\hat{ƒ}ₜ^{c}( ) refers to a local gradient function,
h_{f}^{c}( ) refers to a general function, [symbol]
^{c} refers to a compact convex feasible set, and
α refers to a fixed parameter.

13. The method of claim 9, wherein the local data has a non-zero local delay.

14. The method of claim 9, wherein the local data corresponds to local channel state information, and the local decision vectors correspond to precoding matrices.

15. The method of claim 14, wherein performing the multi-step gradient descent further comprises:
initializing an intermediate precoding matrix \tilde{V}ₜ^{c,0}=\hat{V}ₜ^{c,J}^{ᵣ};
for each step j in the multi-step gradient descent:
(1) constructing an estimated gradient, wherein the estimated gradient is based on H_{t-τ}_{₁}^{c} and Ĝ_{t-τ}^{c}, and
(2) updating \tilde{V}ₜ^{c,j}, by solving an optimization problem for \tilde{V}ₜ^{c,j} based on the estimated gradient;
where:
c is an index referring to a worker node corresponding to the local data,
t refers to the current time slot,
τᵣ refers to a round-trip remote delay,
τ₁ refers to a local delay,
τ refers to the total delay,
Hₜ^{c} refers to the local channel state information,
\hat{V}ₜ^{c,J}^{ᵣ} refers to the global precoding matrix,
Ĝ_{t-τ}^{c}, refers to the global information,
j∈[1,J₁], and
J₁ refers to the number of steps of the multi-step gradient descent.

16. The method of claim 15,
wherein the estimated gradient is given by ∇\hat{ƒ}_{t-τ}_{ᵣ}^{c}(\tilde{V}ₜ^{c,j-1})=H_{t-τ}_{₁}^{c} (H_{t-τ}_{₁}^{c} \tilde{V}ₜ^{c,j-1}+Ĝ_{t-τ}^{c}),
wherein a solution the optimization problem is given by
$${\tilde{V}}_{t}^{c , j} = {𝒫}_{{𝒱}^{c}} \{ {\tilde{V}}_{t}^{c , j - 1} - \frac{1}{α} ∇ {\hat{f}}_{t - {τ}_{l}}^{c} ( {\tilde{V}}_{t}^{c , j - 1} ) \} ,$$
and
wherein the local precoding matrix given by Vₜ^{c}=\tilde{V}ₜ^{c,J}₁;
where:
$${𝒫}_{{𝒱}^{c}} \{ {V}^{c} \} = arg {min}_{{U}^{c} ∈ {𝒱}^{c}} \{ {‖ {U}^{c} - {V}^{c} ‖}_{F}^{2} \}$$
is the projection operator onto the convex feasible set [symbol] ^{c},
∇\hat{ƒ}_{t-τ}_{₁}^{c}( ) refers to a local gradient function, and
α refers to a fixed parameter.

17. A master node adapted to perform the method of claim 1.

18. A worker node adapted to perform the method of claim 9.

19. A master node for performing online convex optimization, the master node comprising processing circuitry and a memory containing instructions executable by the processing circuitry, whereby the processing circuitry is operable to:
receive, from two or more worker nodes, a local decision vector and local data corresponding to each of the two or more worker nodes;
perform a multi-step gradient descent based on the local decision vector and the local data received from the two or more worker nodes, wherein performing the multi-step gradient descent comprises determining a global decision vector and corresponding global information; and
send, to each of the two or more worker nodes, the global decision vector and corresponding global information.

20. A worker node for performing online convex optimization, the worker node comprising processing circuitry and a memory containing instructions executable by the processing circuitry, whereby the processing circuitry is operable to:
receive, from a master node, a global decision vector and corresponding global information, wherein the global information has a time delay associated with it;
perform a multi-step gradient descent based on the global decision vector and local data, wherein performing the multi-step gradient descent comprises determining a local decision vector; and
send, to the master node, the local decision vector and local data.

21. A computer program comprising instructions which when executed by processing circuitry of a node causes the node to perform the method of claim 1.

22. A carrier containing the computer program of claim 21, wherein the carrier is one of an electronic signal, an optical signal, a radio signal, and a computer readable storage medium. a.
